(19) United States
(12) Patent Application Publication
(10) Pub. No.: US 2014/0189081 A1
(43) Pub. Date: Jul. 3, 2014

(54) Methods, Systems, and Computer Program Products for Assigning an Interface Identifier to a Network Interface

(71) Applicant: DEEP RIVER VENTURES, LLC, Raleigh, NC (US)

(72) Inventor: Robert Paul Morris, Raleigh, NC (US)

(73) Assignee: DEEP RIVER VENTURES, LLC, Raleigh, NC (US)

(21) Appl. No.: 13/727,649

(22) Filed: Dec. 27, 2012

(51) Int. Cl. H04L 12/24

(52) U.S. Cl. CPC H04L 41/0806
USPC 709/223

(57) ABSTRACT

Methods and systems are described for assigning an interface identifier to a network interface. In one aspect, a count of network interfaces is detected in a first region of a network that includes a first network interface for operatively coupling a first node to the first region. A threshold condition is determined, based on the count. A first interface identifier is identified that meets, based on a size attribute of the first interface identifier, the threshold condition. The first interface identifier is provided as an identifier of the first network interface.

### RELATED APPLICATIONS

This application is related to the following commonly owned, pending U.S. patent applications by the present inventor, the entire disclosures being incorporated by reference herein:

Application Ser. No. 13/727,647 (Docket No DRV0025) filed on 2012 Dec. 27, entitled “Methods, Systems, and Computer Program Products for Identifying a Protocol Address Based on Path Information”;

Application Ser. No. 13/727,651 (Docket No DRV0027) filed on 2012 Dec. 27, entitled “Methods, Systems, and Computer Program Products for Routing Based on a Nested Protocol Address”;

Application Ser. No. 13/727,652 (Docket No DRV0028) filed on 2012 Dec. 27, entitled “Methods, Systems, and Computer Program Products for Routing Based on a Scope-specific Address Space”;

Application Ser. No. 13/727,653 (Docket No DRV0029) filed on 2012 Dec. 27, entitled “Methods, Systems, and Computer Program Products for Identifying a Protocol address in a Scope-specific Address Space”;

Application Ser. No. 13/727,655 (Docket No DRV0030) filed on 2012 Dec. 27, entitled “Methods, Systems, and Computer Program Products for Determining a Shared identifier for a Hop in a Network”;

Application Ser. No. 13/727,657 (Docket No DRV0031) filed on 2012 Dec. 27, entitled “Methods, Systems, and Computer Program Products for Determining a Hop Identifier for a Network Protocol”; and

Application Ser. No. 13/727,662 (Docket No DRV0032) filed on 2012 Dec. 27, entitled “Methods, Systems, and Computer Program Products for Routing Based on a Path-Based Protocol Address”.

### BACKGROUND

It is unlikely that the designers of the early network, which is referred to as the “Internet”, expected it to become as large as it has become. The fact that the global Internet Protocol (IP) address space, for 32-bit addresses, has been fully allocated is evidence of this. As the Internet grows, new problems will arise and some current problems are getting worse. For example, while network speeds and bandwidth are increasing, so are causes of network latency.

The Internet Engineering Task Force (IETF) has taken steps at various times in the past and are presently taking steps to address a number of problems resulting from the Internet's growth. Problems addressed by the IETF are described in a number of “Request for Comments” (RFC) documents published by the IETF. Documents referenced herein and included by reference include: “Request for Comments” (RFC) document RFC 791 edited by J. Postel, titled ““Internet Protocol, DARPA Internet Protocol Specification”, published by the IETF in September, 1981;

“Request for Comments” (RFC) document RFC 1519 by V. Fuller, et al, titled “Classless Inter-Domain Routing (CIDR): An Address Assignment and Aggregation Strategy”, published by the Internet Engineering Task Force (IEFT), in June, 1999;

“Request for Comments” (RFC) document RFC 2460 by S. Deering, et al, titled “Internet Protocol, Version 6, (IPv6) Specification”, published by the IETF in December, 1998;

“Request for Comments” (RFC) document RFC 3513 by R. Hinden, et al, titled ““Internet Protocol Version 6 (IPv6) Addressing Architecture”, published by the IETF in April, 2003; and

“Request for Comments” (RFC) document RFC 2374 by R. Hinden, et al, titled ““Aggregatable Global Unicast Address Format”, published by the IETF in July, 1998.

RFC 791 states, “The internet protocol implements two basic functions: addressing and fragmentation”. RFC 791 goes on to state, “A distinction is made between names, addresses, and routes. A name indicates what we seek. An address indicates where it is. A route indicates how to get there. The internet protocol deals primarily with addresses. It is the task of higher level (i.e., host-to-host or application) protocols to make the mapping from names to addresses. The internet module maps internet addresses to local net addresses. It is the task of lower level (i.e., local net or gateways) procedures to make the mapping from local net addresses to routes”.

As demonstrated by the RFCs listed above addressing has been a source of a number of problems. In order to address a number of current and future problems facing the Internet, the subject matter described herein challenges the distinctions asserted in RFC 791 and establishes new relationships between and among names, addresses, and routes. The description herein further demonstrates that current internet addresses do not indicate where a node or network interface component (NIC) of a node is. They provide another global identifier space for identifying nodes and their network interfaces. This global identifier space, to some extent, is duplicative of the domain name space that is also a global identifier space for identifying nodes and network interfaces. This duplication of roles is unnecessary as described below.

Accordingly, there exists a need for methods, systems, and computer program products for assigning an interface identifier to a network interface.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for assigning an interface identifier to a network interface. In one aspect, the method includes detecting a count of network interfaces in a first region, of a network, that includes a first network interface operatively coupling a first node to the first region. The method further includes determining, based on the count, a threshold condition. The method still further includes identifying a first interface identifier that meets, based on a size attribute of the first interface identifier, the threshold condition. The method also includes providing the first interface identifier as an identifier of the first network interface. Performing at least one of the above elements in the method includes execution of an instruction by a processor.

Further, a system for assigning an interface identifier to a network interface is described. The system includes a count component operable for and/or otherwise included in detecting a count of network interfaces in a first region, of a network, that includes a first network interface operatively coupling a first node to the first region. The system further includes an address space condition component operable for and/or otherwise included in determining, based on the count, a threshold condition. The system still further includes an address space director component operable for and/or otherwise included in identifying a first interface identifier that meets, based on a size attribute of the first interface identifier, the threshold condition. The system also includes a processor, wherein at least one of the count component, the address space condition component, and the address space director component includes an instruction that is executed by the processor during operation of the system.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for assigning an interface identifier to a network interface according to an aspect of the subject matter described herein;

FIG. 3 is a block diagram illustrating an arrangement of components for assigning an interface identifier to a network interface according to another aspect of the subject matter described herein;

FIG. 4A is a block diagram illustrating an arrangement of components for assigning an interface identifier to a network interface according to another aspect of the subject matter described herein;

FIG. 4B is a block diagram illustrating an arrangement of components for assigning an interface identifier to a network interface according to another aspect of the subject matter described herein;

FIG. 5A is a network diagram illustrating an exemplary system for assigning an interface identifier to a network interface according to another aspect of the subject matter described herein;

FIG. 5B is a network diagram illustrating an exemplary system for assigning an interface identifier to a network interface according to another aspect of the subject matter described herein;

FIG. 5C is a network diagram illustrating an exemplary system for assigning an interface identifier to a network interface according to another aspect of the subject matter described herein;

FIG. 6A is a diagram illustrating an exemplary representation of a protocol address according to another aspect of the subject matter described herein;

FIG. 6B is a diagram illustrating an exemplary representation of a protocol address according to another aspect of the subject matter described herein;

FIG. 6C is a diagram illustrating an exemplary representation of a protocol address according to another aspect of the subject matter described herein; and

FIG. 6D is a diagram illustrating an exemplary representation of a protocol address according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure. It is to be understood that other embodiments and/or aspects may be utilized and structural and functional modifications may be made without departing from the scope of the subject matter disclosed herein.

The use of “including”, “comprising”, “having”, and variations thereof are meant to encompass the items listed thereafter and equivalents thereof as well as additional items and equivalents thereof. Terms used to describe interoperation and/or coupling between components are intended to include both direct and indirect interoperation and/or coupling, unless otherwise indicated. Exemplary terms used in describing interoperation and/or coupling include “mounted,” “connected,” “attached,” “coupled,” “communicatively coupled,” “operatively coupled,” “invoked”, “called”, “provided to”, “received from”, “identified to”, “interoperated” and similar terms and their variants.

As used herein, any reference to an entity “in” an association is equivalent to describing the entity as “included in and/or identified by” the association, unless explicitly indicated otherwise.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the subject matter described herein, suitable methods, components, and devices are described below.

All publications, patent applications, patents, and other references mentioned herein are incorporated by reference in their entirety. In case of conflict, the present disclosure, including definitions, will control. In addition, the materials, methods, and examples are illustrative only and not intended to be limiting.

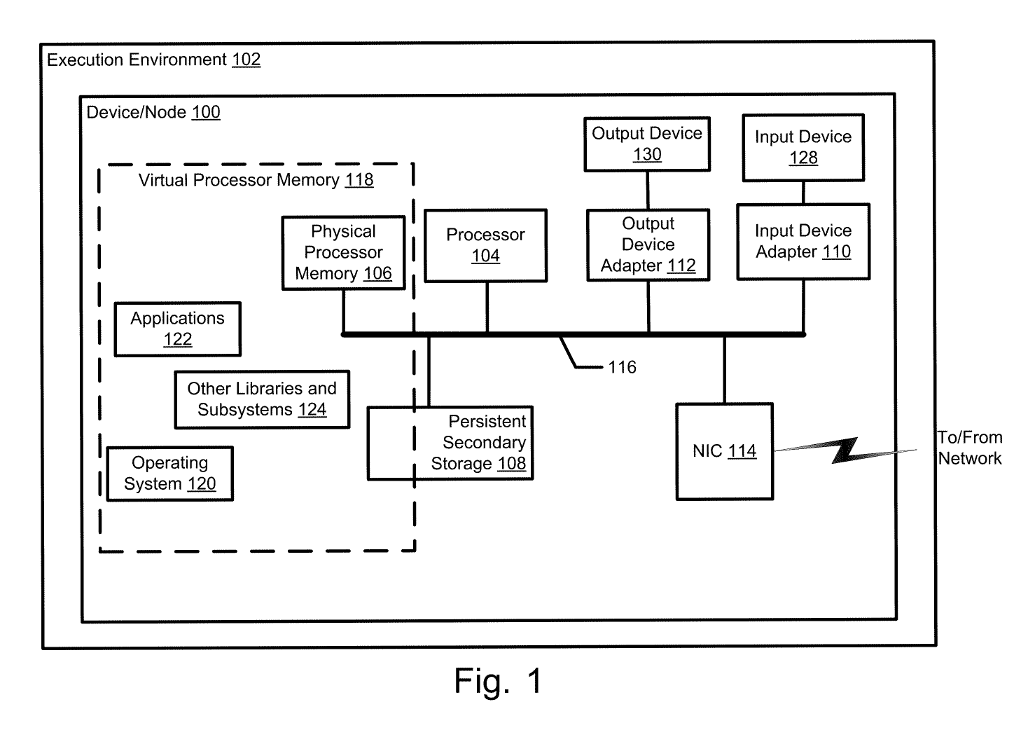

An exemplary device included in an execution environment that may be programmed, adapted, modified, and/or otherwise configured according to the subject matter is illustrated in FIG. 1. An “execution environment”, as used herein, is an arrangement of hardware and, in some aspects, software that may be further modified, transformed, and/or otherwise configured to include and/or otherwise host an arrangement of components to perform a method of the subject matter described herein. An execution environment includes and/or is otherwise provided by one or more devices. The execution environment is said to be the execution environment “of” the device and/or devices. An execution environment may be and/or may include a virtual execution environment including software components operating in a host execution environment. Exemplary devices included in and/or otherwise providing suitable execution environments that may be adapted, programmed, and/or otherwise modified according to the subject matter include a workstation, a desktop computer, a laptop or notebook computer, a server, a handheld computer, a mobile telephone or other portable telecommunication device, a media playing device, a gaming system, a tablet computer, a portable electronic device, a handheld electronic device, a multiprocessor device, a distributed system, a consumer electronic device, a router, a network server, or any other type and/or form of computing, telecommunications, network, and/or media device that is suitable to perform the subject matter described herein. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter to present information to a user; a network interface component, illustrated by a network interface adapter 114, to communicate via a network such as a LAN and/or WAN; and a mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of an instruction and/or may be identified by a register and/or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space including addresses that identify locations in a virtual processor memory is referred to as a “virtual memory address space”; its addresses are referred to as “virtual memory addresses”; and its processor memory is referred to as a “virtual processor memory” or “virtual memory”. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Ferroelectric RAM (FRAM), RAMBUS DRAM (RDRAM) Direct DRAM (DRDRAM), and/or XDR™ DRAM. Physical processor memory 106 may include volatile memory as illustrated in the previous sentence and/or may include non-volatile memory such as non-volatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated computer readable media provide volatile and/or nonvolatile storage for computer-executable instructions, data structures, program components, and other data.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space may be stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding network interfaces such as a serial port, a parallel port, and/or a universal serial bus (USB) port. Input device adapter 110 may receive input and provide a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component. Exemplary network interface components include network interface controllers, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., AMPS, TDMA, CDMA, GSM, GPRS UMTS, and/or PCS network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component to operatively couple the device to a network. Further, the terms “device” and “node” used herein refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include icons, image data, graphical drawings, font characters, windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes, and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A “user interface (UI) element handler” component, as the term is used herein, refers to a component that operates to send information representing a program entity to present a user-detectable representation of the program entity by an output device, such as a display. A “program entity” is an object, such as a variable or file, included in and/or otherwise processed by an application or executable. The user-detectable representation is presented based on the sent information. Information that represents a program entity to present a user detectable representation of the program entity by an output device is referred to herein as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a browser or more generally a user agent from a remote application provider may include HTML, ECMAScript, and/or byte code to present one or more UI elements included in a user interface of the remote application. Components that send information representing one or more program entities to present particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided to store and/or otherwise represent presentation information, which may include audio, visual, tactile, and/or other sensory data for presentation by and/or on an output device. For example, a memory buffer to store an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

An “interaction”, as the term is used herein, refers to any activity including a user and an object where the object is a source of sensory data detected by the user and/or the user is a source of input for the object. An interaction, as indicated, may include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is receiving sensory information from the portable electronic. An interaction may include an input from the user that is detected and/or otherwise sensed by the device. An interaction may include sensory information that is received by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction.

Interaction information for one object may include and/or otherwise identify interaction information for another object. For example, a motion detector may detect a user's head turn in the direction of a display of a portable electronic device. Interaction information indicating that the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus, the interaction information may serve as interaction information for one or more different objects.

As used herein, the terms “program” and “executable” refer to any data representation that may be and/or may be translated into a set of machine code instructions and may optionally include associated program data. The terms are used interchangeably herein. Program representations other than machine code include object code, byte code, and source code. Object code includes a set of instructions and/or data elements that either are prepared to link prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. A program and/or executable may include one or more components, referred to herein as a “program component”, “software component”, and/or “executable component”. As used herein, the terms “application”, and “service” may be realized in one or more program components and/or in one or more hardware components.

As used herein, the term “network protocol” refers to a set of rules, conventions, and/or schemas that govern how nodes exchange information over a network. The set may define, for example, a convention and/or a data structure. The term “network path” as used herein refers to a sequence of nodes in a network that are communicatively coupled to transmit data in one or more data units of a network protocol between a pair of nodes in the network.

A “data unit”, as the term is used herein, is an entity specified according to a network protocol to transmit data between a pair of nodes in a network path to send the data from a source node to a destination node that includes an identified protocol endpoint of the network protocol. A network protocol explicitly and/or implicitly specifies and/or otherwise identifies a schema that defines one or more of a rule for a format for a valid data unit and a vocabulary for content of a valid data unit. One example of a data unit is an Internet Protocol (IP) packet. The Internet Protocol defines rules for formatting an IP packet that defines a header to identify a destination address that identifies a destination node and a payload portion to include a representation of data to be delivered to the identified destination node. Various address types are specified defining a vocabulary for one or more address portions of an IP data unit. The terms “data unit”, “frame”, “data packet”, and “packet” are used interchangeably herein. One or more data units of a first network protocol may transmit a “message” of a second network protocol. For example, one or more data units of the IP protocol may include a TCP message. In another example, one or more TCP data units may transmit an HTTP message. A message may be empty.

How data is packaged in one more data units for a network protocol may vary as the data traverses a network path from a source node to a destination node. Data may be transmitted in a single data unit between two consecutive nodes in a network path. Additionally, data may be exchanged between a pair of consecutive nodes in several data units each including a portion of the data. Data received in a single data unit by a node in a network path may be split into portions included in several respective data units to transmit to a next node in the network path. Portions of data received in several data units may be combined into a single data unit to transmit by a node in a network path. For purposes of describing the subject matter, a data unit in which data is received by a node is referred to as a different data unit than a data unit in which the data is forwarded by the node.

A “protocol address”, as the term is used herein, for a network protocol is an identifier of a protocol endpoint that may be represented in a data unit of the network protocol. For example, 192.168.1.1 is an IP protocol address represented in a human readable format that may be represented in an address portion of an IP header to identify a source and/or a destination IP protocol endpoint. A protocol address differs from a symbolic identifier, defined below, in that a symbolic identifier, with respect to a network protocol, maps to a protocol address. Thus, “www.mynode.com” may be a symbolic identifier for a node in a network when mapped to the protocol address 192.168.1.1. An identifier may be both a symbolic identifier and a protocol address depending on its role with respect to its use for a particular network protocol.

Since a protocol endpoint is included in a node and is accessible via a network via a network interface, a protocol address identifies a node and identifies a network interface of the node. A network interface may include one or more NICs operatively coupled to a network.

A node in a pair of nodes in a network path at one end of the sequence of nodes in the network path and/or the other end is referred to herein as a “path end node”. Note that a node may have two NICs with one NIC at each end of a network path. A network path may be included as a portion of another network path that communicatively couples a same pair of nodes. Data may be transmitted via the sequence of nodes in a network path between path end nodes communicatively coupled via the network path. Data may be transmitted in one or both directions depending on an ordering of the nodes in the sequence.

The term “hop” as used herein refers to a pair of consecutive nodes in a network path to transmit, via a network protocol, data sent from a source node to a destination node. A “hop path” is thus a sequence of hops in a network that respectively include a sequence of pairs of consecutive nodes included in transmitting data from a first path end node of the network path to a second path end node of the network path.

The term “path-based protocol address” as used herein refers to a protocol address for a network protocol that includes one or more path segment identifiers that identify one or more respective portions of a network path identified by the path-based protocol address. A “node-based protocol address” is a path-based protocol address that includes a plurality of node identifiers that identify a sequence of nodes in a network path. A “network-interface-based protocol address” is a path-based protocol address that includes a plurality of interface identifiers that identify a sequence of network interfaces in a network path. A “NIC-based protocol address” is a type of network-interface-based protocol address that includes a plurality of identifiers that identify a sequence of network interface components. A “hop-based protocol address” is a type path-based protocol address since a hop is a type of network path.

Given the above definitions, note that the terms “network path” and “hop” may be defined in terms of network interfaces. A “network path” and a “hop path” include a sequence of network interfaces in a network that are included in transmitting data between a pair of path end nodes in the network. A “hop” refers to at least part of a network path that includes a pair of consecutive network interfaces in a sequence of network interfaces in a network path. A “network path” is thus a sequence of hops in a network that respectively includes a sequence of pairs of consecutive network interfaces included in transmitting data from a first path end node of the network path to a second path end node of the network path.

The term “network topology” or “topology”, for short, as used herein refers to a representation of protocol endpoints and/or nodes in a network, and representations of hops representing communicative couplings between and/or among the protocol endpoints and/or nodes in the network. A network may have different network topologies with respect to different network protocols. A network topology may represent physical communicative couplings between nodes in the network. A network topology may represent logical couplings between protocol endpoints and/or nodes of a particular network protocol or a particular type of network protocol.

The domain name system (DNS) of the Internet operates based on an application layer protocol defined by the DNS. The nodes in the DNS are communicatively coupled via the DNS protocol and may be represented by a logical network topology. A DNS system includes nodes connected via the DNS protocol. The DNS system has a network topology defined by nodes that include protocol endpoints of the DNS protocol. In still another example, a token-ring network has a circular topology at the link layer, but may have a star topology at the physical layer.

As used herein, an “entity-specific address space” refers to an address space defined for a specific entity where the addresses in the address space operate as identifiers in the context of the entity. An address from an entity-specific address space is referred to herein as an “entity-specific address”. An address is “entity-specific” in that what it identifies is based on the entity to which it is specific. Another address having the same form and content may identify a different entity when in an address space specific to another entity. Addresses in an entity-specific address space operate as identifiers in the context of an entity to which they are “specific” as defined by the specific association of the address space and the entity. Without knowledge of the entity to which an entity-specific address space is specific, what an address in the entity-specific address space identifies is indeterminate. The terms “entity-specific address” and “entity-specific identifier” are used interchangeably herein. An entity-specific address may identify an entity included in the entity to which the address is specific or may identify an entity external to the entity to which the address is specific. The fact that an address is entity-specific does not define a scope for the address.

A portion of a network is a type of entity. A type of entity-specific address space described herein is a scope-specific address space. As used herein, a “scope-specific address space”, specific to a particular region of a network, is an address space defined for the particular network region, where an address in the scope-specific protocol address operates as identifier, according to a network protocol, of a protocol endpoint in a node outside of the particular region when processed in the context of a node in the particular region. The region is indicated by the span of an indicated scope. The terms “region” and “zone” are used interchangeably herein. An address from a scope-specific address space is referred to herein as a “scope-specific protocol address”. An address is “scope-specific” in that what protocol endpoint it identifies depends on the region to which it is specific. Another address having the exact same form and content may identify a different protocol endpoint when in an address space that is specific to another region. A protocol address in a scope-specific address space serves as an identifier in the context of a node in a region to which the scope-specific address space is “specific” as defined by an association of the address space and the region indicated by the scope. Without knowledge of the particular region to which a scope-specific address space is specific, what a scope-specific protocol address in the scope-specific address space identifies is indeterminate. The terms “scope-specific protocol address” and “scope-specific protocol identifier” are used interchangeably herein. Types of scope-specific address spaces indicating exemplary spans include site-specific, LAN-specific, subnet-specific, city-specific, business-specific, and node-specific.

For a network protocol, an address in a scope-specific address space serves as an identifier of a protocol endpoint in a node. Data may be received via the protocol endpoint from a network via one or more network interfaces that operatively couple the node to the network. Data may be sent via the protocol endpoint to transmit over the network via the one or more network interfaces in the node. Since a protocol endpoint of a network protocol is included in a node and is accessible via a network via a network interface, a protocol address identifying the protocol endpoint also identifies the node and identifies a network interface of the node.

As used herein, a “node-specific address space” is a scope-specific address space defined for a specific node in a network, where the addresses in the node-specific address space operate as identifiers of nodes and/or network interfaces in the network when processed in the context of the specific node. An address from a node-specific address space is referred to herein as a “node-specific address”. An address is “node-specific” in that what it identifies depends on the node to which is defined as specific. Another address having the exact same form and content may identify a different node when in an address space specific to another node. Addresses in a node-specific address space operate as identifiers in the context of a node to which they are “specific” as defined by the specific association of the address space and the node. Without knowledge of the node to which a node-specific address space is specific, addresses in the node-specific address space are indeterminate. The terms “node-specific address” and “node-specific identifier” are used interchangeably herein. A node-specific address space is a type of scope-specific address space.

The term “node” is defined above. Note that an identifier of a network interface in a network also identifies a node that includes the network interface. Thus, a network interface-specific address is also a node-specific address. Network interfaces in a node may have their own respective network interface-specific address spaces that are also node-specific. The network interface-specific address spaces may be combined to form a node-specific address space and/or may be managed as separate address spaces. The adjectives “node-specific” and “network interface-specific” may be used interchangeably.

A scope-specific identifier differs from a scoped address as described in “Request for Comments” (RFC) document RFC 4007 by S. Deering, et al, titled “IPv6 Scoped Address Architecture”, published by the IETF in December, 2006 and further described in application Ser. No. 11/962,285, by the present inventor, filed on 2007 Dec. 21, entitled “Methods and Systems for Sending Information to a zone Included in an Internet Network”. A scoped address space is shared by nodes in a given scope. While a link-local scoped address is specific to a particular node, a link-local scoped address simply identifies a network interface component local to the particular node. A loop-back internet address is specific to a node as well. Neither link-local scoped addresses nor loop-back addresses identify one node to another. As such, neither serves as a node-specific identifier as defined above.

A “scoped address” is described by RFC 3513 and RFC 4007 as an identifier that, in a particular region of a network, serves as a protocol address of a network interface and/or a node in the particular region. The extent of the particular region is referred to as the scope of the region and thus the scope within which the identifier serves as a protocol address. A particular region included within a scope is indicated by its span. A scoped address is a valid protocol address only within a particular region as indicated by the address's indicated scope. Examples of scope indicators include node-scope where identifiers are valid only to a single node in the indicated span, LAN-scope where identifiers are valid for nodes in the span of a particular LAN, and subnet-scope where identifiers are valid only for nodes in a particular subnet. RFC 3513 currently defines support for link-local scope, site-local scope, and global scope. A data unit transmitted with a scoped address should not be delivered to node that does not have a network interface in the span indicated by the scope.

“Path information” is any information that identifies a network path and/or a hop path for data transmitted via one a specified network protocols. Path information may be identified by identifying network interfaces, NICs, nodes, and/or hops included in a network path. “Address information” is any information that identifies a protocol address that, for a network protocol, identifies a protocol endpoint. Address information may identify a unicast protocol address for a network protocol. In identifying a protocol endpoint, a protocol address identifies a node and a network interface.

Those skilled in the art will understand upon reading the descriptions herein that the subject matter disclosed herein is not restricted to the network protocols described and/or their corresponding OSI layers. For ease of illustration, the subject matter is described in terms of protocols that correspond to OSI layer three, also referred to as network layer protocols, in general. Particular descriptions are based on versions of the Internet Protocol (IP). Address information may identify one or more protocol addresses. Exemplary protocol addresses include IP addresses, IPX addresses, DECNet addresses, VINES Internet Protocol addresses, and Datagram Delivery Protocol (DDP) addresses, HTTP URLS, TCP port and IP address pairs, and the like.

The term “path-based address” is defined above. A “node-based address” is a path-based address where some or all of the address includes node identifiers that identify a sequence of nodes in a network path. A “network-interface-based address” is a path-based address where some or all of the address includes identifiers of network interfaces in a sequence in a network path. A “NIC-based address” is a type of network-interface-based address that identifies a sequence of network interface components. A “hop-based address” is a path-based address where some or all of the address identifies one or more hops in a network path. The protocol address types defined are not mutually exclusive.

The term “metric space”, as used herein, refers to a set, as defined in mathematics, where a distance between elements of the set is defined according to a metric. Metric spaces defined in Euclidean geometry are well-known examples. Those skilled in the art of metric spaces, such as Euclidian spaces, will appreciate that a one-to-one mapping may be determined and/or otherwise identified for mapping addresses from a first coordinate space having a first origin for a metric space to addresses from a second coordinate space having a second origin in the metric space. Given a mapping rule between a first scope-specific address space and a second scope-specific address space and a mapping between the second scope-specific address space and a third scope-specific address space based on a third coordinate space identifying a third origin in the metric space, a mapping from the first coordinate space to the third coordinate space may be determined. A mapping between coordinate spaces for a metric space may be included a coordinate shift and/or a rotation, for example. The mapping may be pre-specified and accessible to the nodes in one or both address spaces. Mapping between locations in a number of different metric spaces is well known in mathematics. For example, a top half of the surface of sphere may be mapped to a plane. Some will further appreciate that some metric spaces may be mapped to other metric spaces. Some of these mappings are one-to-one and/or onto.

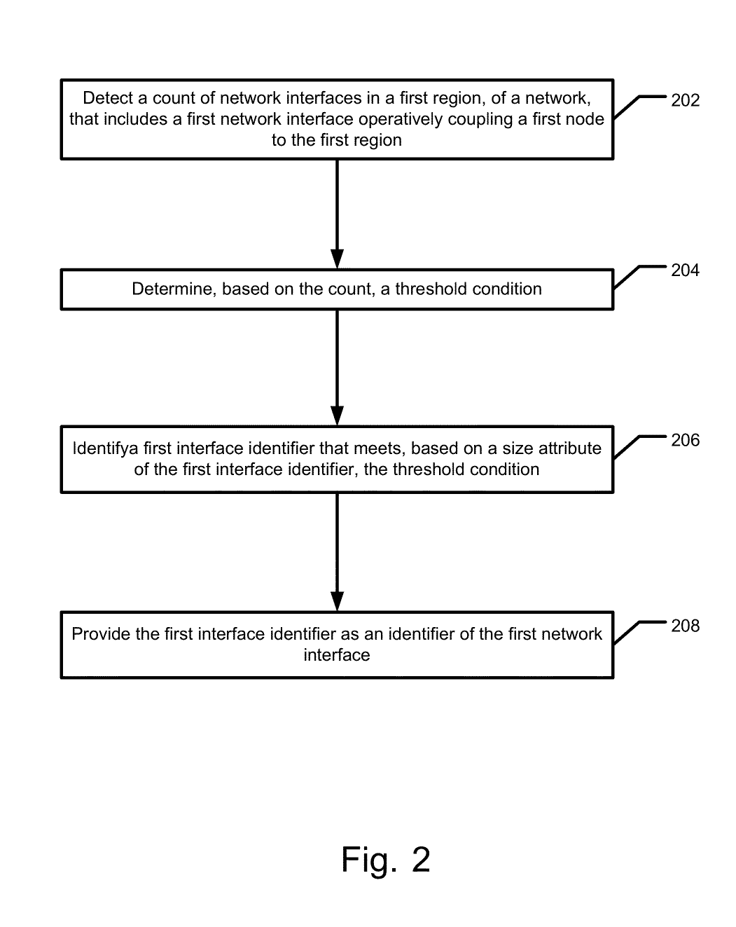

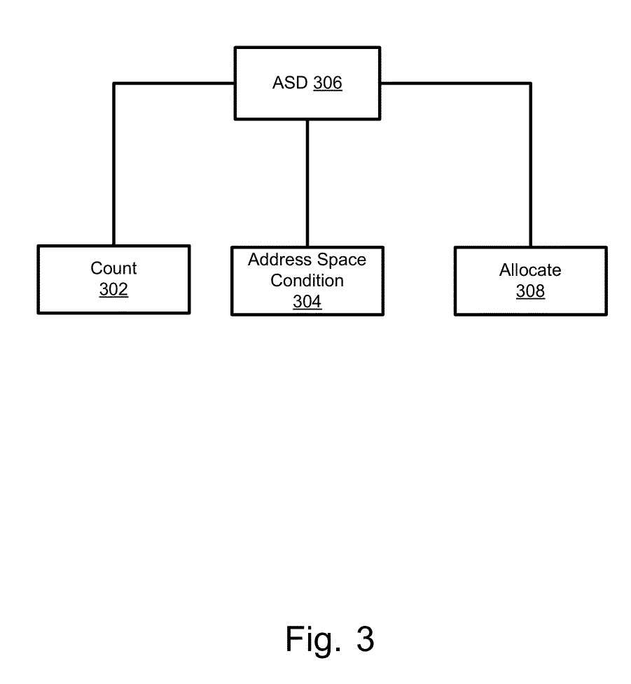

FIG. 3 illustrates an arrangement of components in a system that operates in an execution environment, such as execution environment 102 in FIG. 1. The arrangement of components in the system operates to perform the method illustrated in FIG. 2. The system illustrated includes a count component 302, an address space condition component 304, an address space director component 306, and an allocate component 308. A suitable execution environment includes a processor, such as the processor 104, to process an instruction in at least one of the count component 302, the address space condition component 304, the address space director component 306, and the allocate component 308.

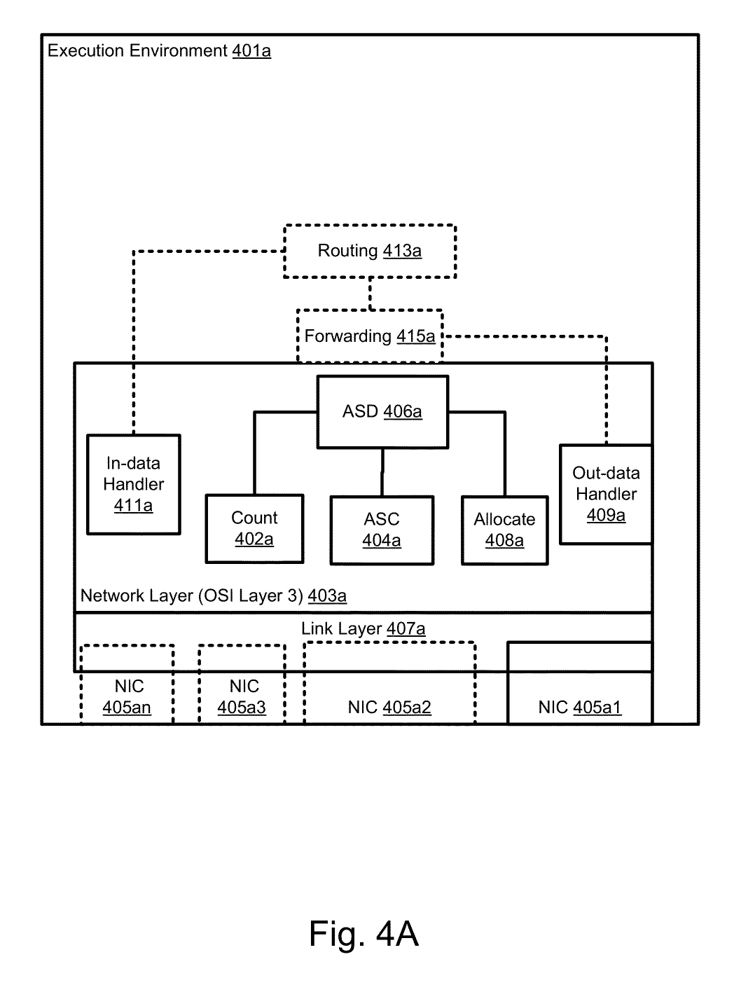

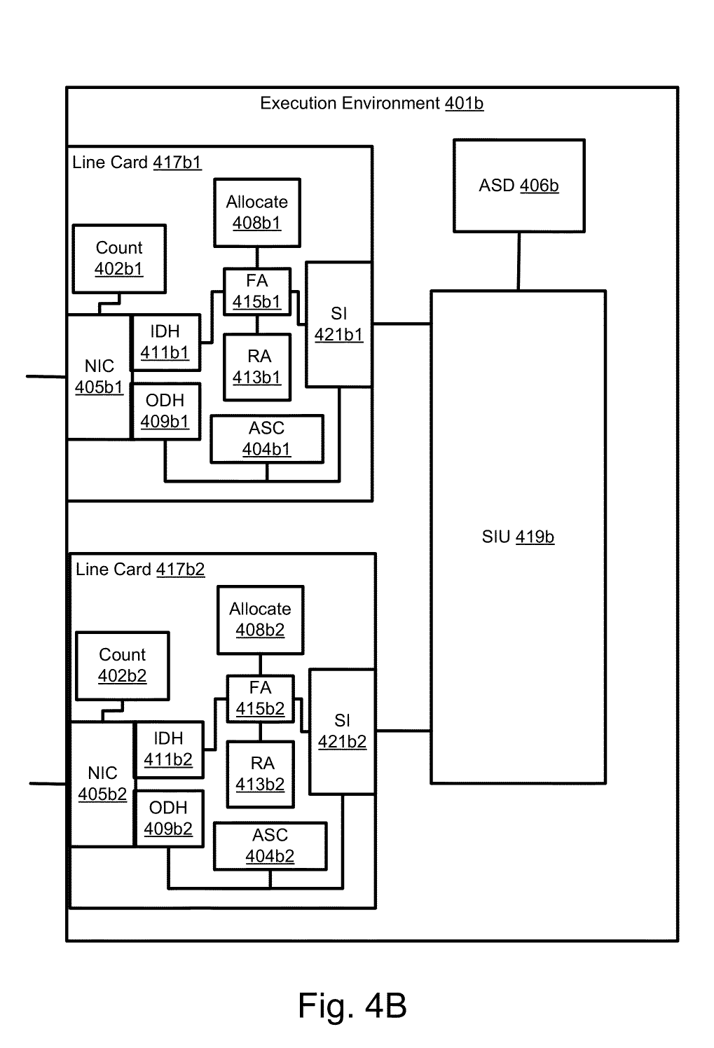

Some or all of the exemplary components illustrated in FIG. 3 may be adapted to perform the method illustrated in FIG. 2 in a number of execution environments. FIGS. 4A-B are each block diagrams illustrating the components of FIG. 3 and/or analogs of the components of FIG. 3 respectively adapted to operate in execution environment 401a and execution environment 401b that each include and/or otherwise are provided by one or more nodes. Components, illustrated in FIG. 4A and FIG. 4B, are identified by numbers with an alphanumeric suffix. Execution environments; such as execution environment 401a and execution environment 401b, and their adaptations and analogs; are referred to herein generically as execution environment 401 or execution environments 401 when describing more than one. Other components identified with an alphanumeric suffix may be referred to generically or as a group in a similar manner.

FIG. 1 illustrates key components of an exemplary device that may at least partially provide and/or otherwise be included in an execution environment. Some or all of the components illustrated in FIG. 4A and FIG. 4B may be included in or otherwise combined with the components of FIG. 1 to create a variety of arrangements of components according to the subject matter described herein. Those skilled in the art will understand that various adaptations of the arrangement in FIG. 3 illustrated and described herein, as well as the execution environments suitable described herein for hosting an adaptation of the arrangement in FIG. 3 are not exhaustive.

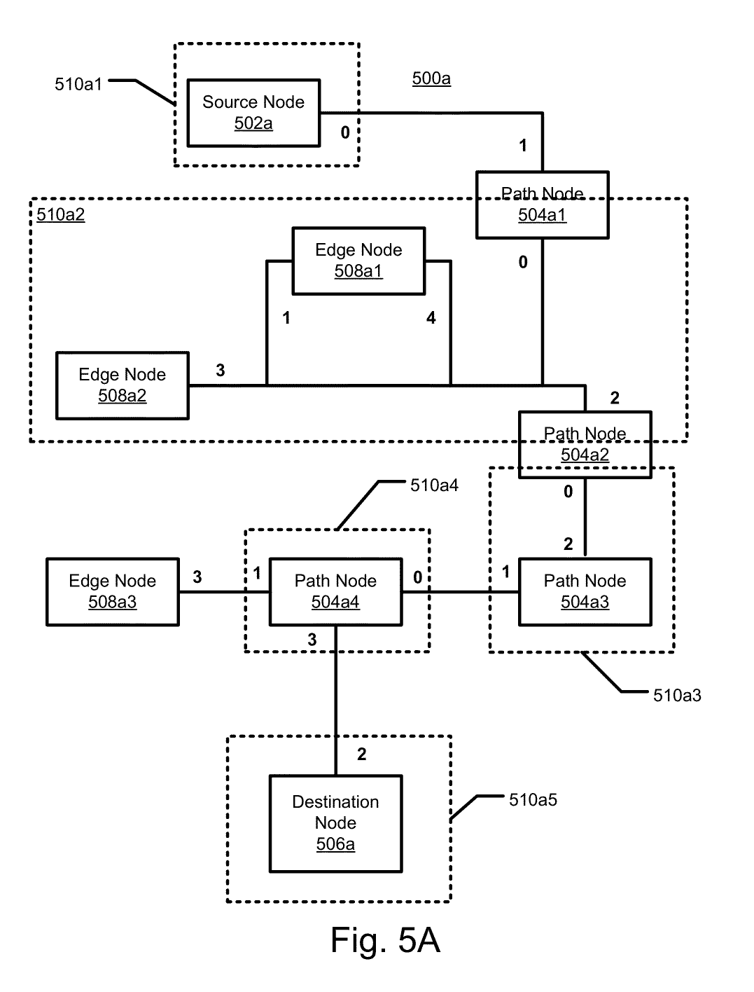

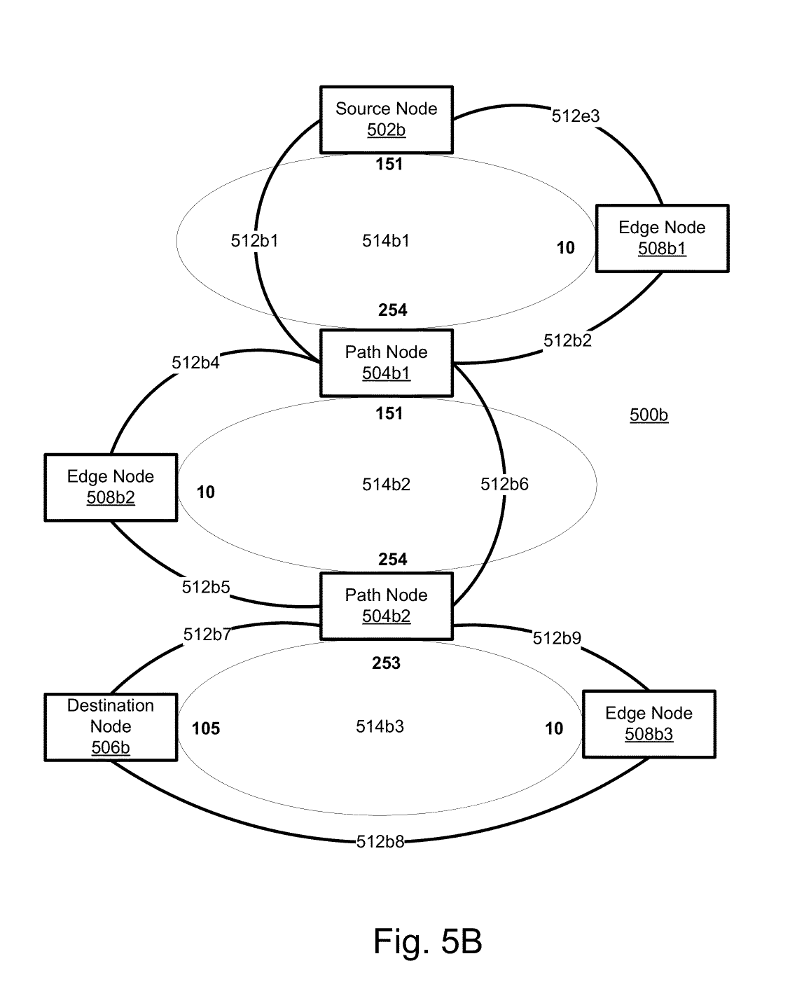

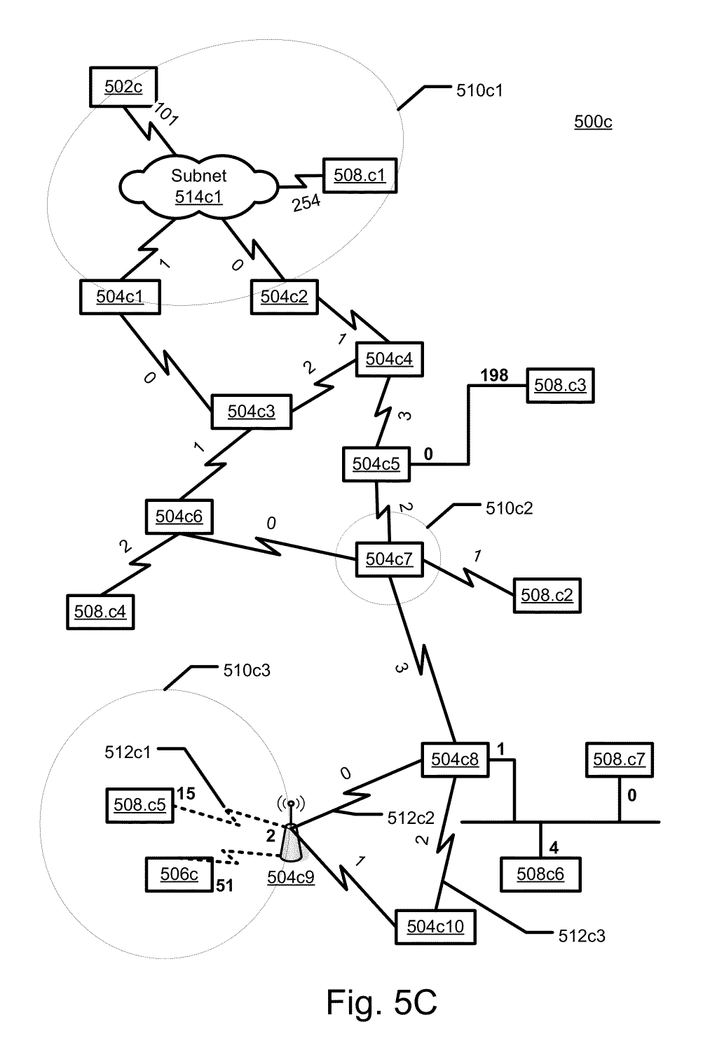

FIGS. 5A-C respectively illustrate networks 500 including nodes that in various aspects may include adaptations, analogs, and/or instances of any of the execution environments 401, illustrated in FIG. 4A and FIG. 4B. The various illustrated nodes are operatively coupled or may be operatively coupled via network interface components to the respective networks 500 in FIGS. 5A-C. For ease of illustration and description, each of FIGS. 5A-C includes nodes identified by a role played in sending data from one node to another. FIGS. 5A-C illustrate source nodes 502 configured to initiate a transmission of data to respective recipients, path nodes 504 configured to relay the data transmitted by respective source nodes 502, and destination nodes 506 including protocol endpoints identifying respective recipients of the data sent by the source nodes 502. In some of FIGS. 5A-C, one or more edge nodes 508 are illustrated for describing adaptations of the arrangement in FIG. 3 performing various aspects of the method illustrated in FIG. 2 operating in the role of a destination node and/or in the role of a source node.

FIG. 5B illustrates a network path communicatively coupling the source node 502b and a second edge node 508b2 in the network 500b that includes a sequence of nodes including of the source node 502b, a first path node 504b1, and the second edge node 508b2. In FIG. 5C, a first network path communicatively coupling a fifth edge node 508c5 and an eighth path node 504c8 includes a first sequence of nodes including the fifth edge node 508c5, a ninth path node 504c9, and the eighth path node 504c8. The first network path is included in a second network path communicatively coupling the fifth edge node 508c5 and the second edge node 508c2 that includes a second sequence of nodes including the nodes in the first sequence, a seventh path node 504c7, and the second edge node 508c2. A network path may be physical network path or logical network path based on a particular network protocol defining protocol endpoints in the path end nodes.

In various contexts, nodes illustrated as destination nodes 506, edge nodes 508, and/or path nodes 504 may operate as source nodes; and nodes illustrated as source nodes 502, edge nodes, 508, and/or path nodes 504 may operate as destination nodes. Exemplary nodes configured to operate as path nodes 504 include a router, a switch, a wireless access point, a bridge, a gateway, and the like.

A path node 504 illustrated in any of FIGS. 5A-C and/or a node otherwise operating as a path may include and/or be included in an instance and/or adaptation of any execution environment 401 illustrated in FIG. 4A and FIG. 4B. A path node 504 may include a first network interface component and a second network interface component. With respect to FIG. 5B, a first path node 504b1 may be operatively coupled to a first network region 514b1 included in a network 500b via a first network interface component, and may be operatively coupled to a second network region 514b2 via a second network interface component. The first path node 504b1 may forward data sent from a source node 502b in the first network region 514b1 for delivery via a second network region 514b2 to a destination node 506b in a third network region 514b3. The first network region 514b1, the second network region 514b2, and/or the third network region 514b3 may respectively include and/or may be included in a local area network (LAN), an intranet, at least a portion of the Internet, and/or another wide area network (WAN).

Network components in some nodes may be configured according to a layered design or architecture known to those skilled in the art as a “network stack”. Adaptations, analogs, and/or instances of execution environments 401 in FIG. 4A and FIG. 4B may include network components in a layered architecture, physically and/or logically. Other architectural models for network components may be included in other execution environments for sending and receiving data via a network, and are considered within the scope of the subject matter described herein. Combinations of layered architectures and non-layered architectures are also considered to be within the scope of the subject matter described herein.

Some components illustrated in FIG. 4A correspond to components of the layered architecture specified by the Open System Interconnection (OSI) model, known to those skilled in the art. For example, network components in FIG. 4A may comply with specifications for protocols included in the TCP/IP protocol suite. The OSI model specifies a seven-layer stack. The TCP/IP protocol suite may be mapped to layers three and four of the seven layers. Those skilled in the art will understand that fewer or more layers may be included in various adaptations, analogs, and/or instances of execution environments 401 illustrated in FIG. 4A, FIG. 4B, and in their various aspects described herein; and for any other execution environment suitable for hosting an adaptation and/or analog of the arrangement of components illustrated in FIG. 3.

FIG. 4A illustrates a network layer component 403a that operates according to and/or otherwise corresponds to layer three of the open systems interconnection reference (OSI) model. The Internet Protocol (IP) is an exemplary layer 3 protocol, also referred to as a network layer protocol. FIG. 4A illustrates a first NIC 405a1 configured to operatively couple a node including an adaptation, analog, and/or instance of the execution environment 401a to a network. One or more NICs 405a may operate according to and/or otherwise correspond to layer one, also known as the physical layer, of the OSI model for receiving and sending signals via a physical data transmission medium.

FIG. 4A also illustrates a link layer component 407a that operates according to and/or otherwise corresponds to layer two, also known as the link layer, of the OSI model to communicate, via layer one, between nodes sharing a physical data transmission medium such as nodes in a LAN. Exemplary link layer protocols include an Ethernet protocol, a Token-ring protocol, and asynchronous transfer mode (ATM) protocol, to name a few. Some or all of the link layer component 407a may be included in one or more NICs. Some or all of a link layer component may be external to and operatively coupled to one or more NICs. An external portion may be realized, at least in part, as a device driver for the one or more NICs. Exemplary physical data transmission media include Ethernet cables of various types, co-axial cables, fiber optic cables, and media suitable for transporting various types of wireless signals.

The network layer component 403a, illustrated in FIG. 4A, may operate to communicate across various types of link layer protocols, in various adaptations. Layer three protocols enable data to be exchanged between and among nodes on different networks across different types of physical data transmission media and differing link layer protocols. The Internet Protocol (IP) in the TCP/IP protocol is the most widely utilized network layer protocol currently in use. For ease of illustration, the description that follows provides examples based on IP networks and protocols in the TCP/IP suite due to their wide use and because they are well known in the art. Those skilled in the art will understand that the scope of the subject matter described is not limited to IP networks.

Data may be received by an out-data handler component 409a to transmit to another node from an application (not shown) operating in the execution environment 401a. The data may be provided to the out-data handler component 409a directly from the application and/or indirectly via one or more higher layer protocol components. For example, the application may interoperate with a sockets component, known to those skilled in the art, to open a socket for accessing a protocol endpoint of the transmission control protocol (TCP) and/or for accessing a protocol endpoint of the user datagram program (UDP).

The out-data handler component 409a may buffer the data to transmit via the link layer component 407a. The out-data handler component 409a may retrieve and/or otherwise receive data, and package the data in one or more data units of the network layer protocol of the network layer component 403a. The out-data handler component 409a may identify a network interface to transmit the data based on address information included in the one or more data units. The out-data handler component 409a may provide the one or more data units to the link layer component 407a to package the network layer data units in link layer data units. The link layer component 407a may interoperate with one or more NICs 405a that are included in the network interface identified by the out-data handler component 409a.

FIG. 4A, illustrates an in-data handler component 411a that may operate in a path node 504. The in-data handler component 411a may receive a data unit including data sent from a source node 502 to an identified destination node 506. The data unit may be received by a NIC, such as a first NIC 405a1 in the path node 504, where the NIC is included in a network path from the source node 502 to the path node 504. The data unit may be a link layer data unit provided to a link layer component 407a. The link layer component 407a may provide data in one or more link layer data units to the in-data handler component 411a. The in-data handler component 411a may detect a network layer data unit in the data from the link layer component 407a. The data from the source node 502 may be received in one or more network layer data units.

The in-data handler component 411a may send address information detected in the one or more network layer data units to a routing agent component 413a included in the execution environment 401a for the path node 504. The routing component 413a may determine a next NIC 405a to relay the data received from the source node 502 in the one or more data units received via the first NIC 405a1. The routing component 413a may interoperate with a forwarding component 415a to identify the next network interface to relay the data to the destination node 506. The forwarding component 415a may identify that a second NIC 405a2 is included in the next network interface, based on address information included in the one or more received data units. The forwarding component 415a may direct an out-data handler component 409a in the path node 504 to retrieve and/or otherwise receive the data from the in-data handler component 411a to package and transmit via the link layer component 407a and the second NIC 405a2 as described above.

In addition to the protocols described above, protocols corresponding to layers in the OSI model above the network layer may be included in communicating via a network. The term “application protocol” as used herein refers to any protocol or combination of protocols that correspond to one or more layers in the OSI reference model above the network layer. Programs and executables, operating in an execution environments 401, may communicate via one or more application protocols. Exemplary application protocols include the transmission control protocol (TCP) in the TCP/IP suite, the user datagram protocol (UDP) in the TCP/IP suite, various versions of hypertext transfer protocol (HTTP), various remote procedure call (RPC) protocols, various instant messaging protocols, various email protocols, and various other protocols for real-time communications.

Data exchanged between nodes in a network may be exchanged via data units of one or more network protocols. An execution environment may include layer specific protocol components respectively configured according to the one or more network protocols. Some protocols and/or protocol components may define and/or provide services from multiple layers of the OSI model layer such as the Systems Network Architecture (SNA) protocol.

In addition to explicitly and/or implicitly specifying schemas defining valid data units, a network protocol may define and/or otherwise be associated with a defined identifier space for identifying protocol endpoints defined according to the network protocol. The terms “identifier space” and “address space” are used interchangeably herein. For example, various versions of hypertext transfer protocol (HTTP) specify a format for HTTP uniform resource locators (URL). HTTP specifies a location in an HTTP header that identifies a URL as an identifier or address from the HTTP address space that identifies both a resource and recipient of an HTTP data unit. The transmission control protocol (TCP) specifies a format and vocabulary for a TCP header including a destination protocol endpoint identifier field referred to as a destination port number that, when combined with a destination protocol address from an IP packet, identifies a transport layer protocol endpoint of a receiver of data sent in a TCP data unit via a network. A source protocol endpoint is similarly identified by a source port number, included in a TCP header as defined by the TCP, along with a source protocol address from an IP data unit as defined by the Internet Protocol.

Other exemplary address spaces that identify protocol endpoints in various network protocols include an email address space, a telephone number address space for various telephony protocols, instant message address spaces for various instant message protocols, and media access control (MAC) addresses for various link layer protocols, to name just a few examples.

In delivering data via a network between protocol endpoints of a particular network protocol, addresses from address spaces of the various protocols at the various layers are typically translated and/or otherwise mapped between the various layers. For example, a unicast IP address in an IP packet is mapped to a link layer address for a link the IP packet is transported across in a network path via a path node 504 in relaying data from a source node 502 to an identified destination node 506. Addresses at the various layers are assigned from a suitable address space for corresponding network protocols.

FIG. 4B illustrates another exemplary execution environment 401b that may be included in a path node 504 illustrated in FIGS. 5A-C. In FIG. 4B, the execution environment 401b includes line cards 417b that respectively include NICs 405b. A first NIC 405b1 may operatively couples the path node 504 to a previous network path with respect to data from a source node 502 to relay to a destination node 506. A second NIC 405b2 may operatively couple the path node 504 to a next network path with respect to the data from the source node 502.

Data sent from a source node 502 to deliver to an identified destination node 506 may be received in a data unit of a network protocol by a NIC of the path node 504, such as the first NIC 405b1. The data may be detected by an in-data handler (IDH) component 411b1 operatively coupled to the first NIC 405b1. The in-data handler component 411b1 may send address information received in the data unit to a routing agent component 413b1. Routing agent (RA) components 413b are functionally analogous to a routing component 413a included in some adaptations of the execution environment 401a. An RA component 413b may determine a next NIC 405b to relay data received in a data unit via a previous NIC 405b.

The RA component 413b1 may interoperate with a forwarding agent (FA) component 415b1 to identify a second line card 417b2 including a second NIC 405b2, based on the address information received in the data unit including data from the source node 502. FA components 415b are functionally analogous to forwarding routing components 415a that may be included in some adaptations of the execution environment 401a. The first FA component 415b1 may modify a switch interconnect unit (SIU) 419b to provide a communication channel from the first line card 417b1 to the second line card 417b2 and vice versa, as needed. A line card 417b may include a switch interface (SI) component 421b for writing data to a channel configured in the SIU component 419c and/or for reading data from a channel.

The first FA 415b1 may setup a channel in the SIU component 421b to communicate the data from the source node 502 via a first SI component 421b1 to a second SI component 421b2 of the second line card 417b2. The second SI component 421b2 may read the data communicated via the SIU component 419b and provide the data to a second out-data handler (ODH) component 409b2 in the second line card 417b2 to transmit to the next node. The second ODH component 409b2 may package the data in one or more data units of the network protocol. The out-data handler component 409b2 may interoperate with the second NIC 405b2 to transmit the data via a data transmission medium to which the second NIC 405b2 is operatively coupled. Data may be relayed from the destination node 506 to the source node 502 in an analogous manner. FIG. 4A illustrates that at least some path nodes 504, that are and/or otherwise provide an adaptation, analog, and/or instance of the execution environments 401, may include more than one NIC 405, as illustrated by a second NIC 405a2 through an Nth NIC 405an in FIG. 4A. Adaptations of the execution environment 401b in FIG. 4B may include more than the two line cards 417b and respective NICs 405b illustrated in the figure.

FIG. 5B, illustrates a number of network paths communicatively coupling the source node 502b and the destination node 506b in the network. One network path illustrated includes a sequence of hops including a first hop 512b1, a sixth hop 512b6, and a seventh hop 512b7. In FIG. 5C, a first network path communicatively coupling the fifth edge node 508c5 and the eighth path node 504c8 includes a first sequence of hops including a first hop 512c1 and a second hop 512c2. In FIG. 5B, the network path described above communicatively coupling the source node 502b and the destination node 506b includes a sequence of network interfaces including a network interface in the first path node 504b1 in the first hop 512b1, a network interface in a second path 504b2 in a sixth hop 512b6, and network interface in the destination node 506b in a seventh hop 512b7.

As the term “network topology” is defined herein, a network may have different network topologies with respect to different layers and/or network protocols and their corresponding protocol endpoints. A network topology may represent physical communicative couplings between nodes in the network. A network topology may represent logical hops in a network. In FIG. 5B, the first network 514b1 may represent a physical topology when the first network 514b1 represents a physical data transmission medium included in physically coupling nodes. The data transmission medium may be an Ethernet LAN, for example. The hops 512 in FIG. 5 may illustrate logical communicative couplings at a level of the network above the data transmission medium. The hops 512 may represent link layer hops, network layer hops, or hops at some other layer of the network above the data transmission medium or physical layer.

With reference to FIG. 2, a block 202 illustrates that the method includes detecting a count of network interfaces in a first region, of a network, that includes a first network interface operatively coupling a first node to the first region. Accordingly, a system for assigning an interface identifier to a network interface includes means for detecting a count of network interfaces in a first region, of a network, that includes a first network interface operatively coupling a first node to the first region. For example, the arrangement illustrated in FIG. 3, includes count component 302 operable for and/or otherwise included in detecting a count of network interfaces in a first region, of a network, that includes a first network interface operatively coupling a first node to the first region.

FIG. 4A and FIG. 4B illustrate count components 402 as adaptations and/or analogs of count component 302 in FIG. 3. One or more count components 402 operate in an execution environment 401. In FIG. 4A, a count component 402a is illustrated as a component of the network layer component 403a. In FIG. 4B, a count component 40b is illustrated as a component of a line card component 411b.

A region may include a single node with one or more network interfaces in the region and with no other network interfaces of other nodes in the region. All of the one or more network interfaces in the node may be in the region. Such a region is illustrated by a first region 510a1 including a source node 502a in FIG. 5A. The first region 510a1 illustrates a region that includes a single node, the source node 502a. The source node 502a may be included in and/or otherwise may be included in providing an adaptation, analog, and/or instance of execution environment 401a. The execution environment 401a may include a single network interface that may include a first NIC 405a1.

A node may include a network interface included in a region and may include another network interface not in the region. In FIG. 5A, a second path node 504a2 is illustrated having a network interface included in a second region 510a2 and another network interface included in a third region 510a3. A node may have a single network interface in a region and/or multiple network interfaces in a region.

A count or a partial count of network interfaces in a node in a particular region may be detected by a node in the region or by a node in another region. A count component 402a in the source node 502a may detect the first NIC 405a1 in detecting a count of network interfaces in the first region 510a1. Detecting a count may include receiving count information identifying the count or a portion of the count, in response to a user input detected by an input device via a node. In an aspect, a count of network interfaces and/or of NICs in one or more network interfaces in the source node 502a may be a configuration setting set in response to an input detected from a user via an input device, such as described with respect to FIG. 1. The configuration setting may be accessed and/or otherwise detected by the count component. 402a in the source node 502a.

A node may include more than one network interface component in a region of a network. In FIG. 5A, a fourth path node 504a4 may be and/or may include an adaptation, analog, and/or instance of execution environment 401b. FIG. 5A illustrates the fourth path node 504a4 includes three network interfaces in a fourth region 510a4. The three network interfaces may respectively include a first NIC 405b1 in a first line card 417b1, a second NIC 405b2 in a second line card 417b2, and a third NIC in a third line card (not shown). In FIG. 5A, a first edge node 508a1 may be and/or may include an adaptation, analog, and/or instance of execution environment 401a. The first path node 508a1, as illustrated in FIG. 5A, may include a first NIC 405a1 and a second NIC 405a2 in the second region 510a2. A node in the second region 510a2 operating to detect a count of network interfaces in the region may detect the two network interface components, based on a detected user input as described above and/or by interaction via the network 500a with the edge node 508a1 and/or other nodes in the second region 510a2 and/or otherwise in the network 500a.

Detecting a count may include detecting whether network interface components in a region are in the same node. Detecting the count may further include determining that the network interface components are coupled to a same data transmission medium. Whether network interface components in the same node are coupled to a same data transmission medium may affect how network interfaces are counted. In an aspect, the network interfaces components in the same node coupled to the same data transmission medium may be included in a single network interface and counted as such. In the first edge node 508a1, the first NIC 405a1 and the second NIC 405a2 may be defined to be included in a first network interface. The count component 402a in the first edge node 508a1 and/or a count component 402 in another node in the network 500a may count one network interface in the second region 510a2 in the first edge node 508a1. The network interface components in the network interface may be assigned the same protocol address for a particular protocol, such a network layer protocol. The internet protocol in the TCP/IP suite is an exemplary network layer protocol. Network interface components assigned the same protocol address may be counted as a single network interface when a count is for a network protocol of the protocol addresses.

In another aspect, multiple network interface components in a node may be operatively coupled to a same data transmission medium and may be included in more than one network interface for counting. Returning to the first edge node 508a1 in FIG. 5A, the first NIC 405a1 and the second NIC 405a2 the may be defined to be included in a first network interface and a second network interface, respectively. The count component 402a in the first edge node 508a1 and/or a count component 402 in another node in the network 500a may count two network interfaces in the second region 510a2 in the first edge node 508a1. The first NIC 405a1 may be associated with, for example, a first IP address. The second NIC 405a2 may be associated with a second IP address. Thus a node that includes multiple network interface components coupled to a same data transmission medium, may have a network interface component in the multiple network interface components in one network interface and another network interface component in the multiple network interface components may be included in another network interface.

Count information including and/or otherwise identifying a count or a portion of a count may be received via at least one of a link layer protocol component and a network interface device driver. In FIG. 5B, a destination node 506b, in a network 500b, is illustrated that may be and/or may include an adaptation, analog, and/or instance of execution environment 401a in FIG. 4A. The destination node 506b, in an aspect, may be in a region defined by network interfaces in a third network 514b3 in the network 500b. A count component 402a may detect a network interface in a second path node 504b2 by exchanging and/or otherwise detecting an exchange of a message between the destination node 506b and the second path node 504b2. The second path node 504b2 may be the recipient of a message and/or may initiate sending a message. In another aspect, the second path node 504b2 may operate to relay a message between the destination node 506b and another node, such as a source node 502b.

FIG. 4B, illustrates a count component 402b1 operatively coupled to the first NIC 405b1. The count component 402b1 may be included in the first NIC 402b1 and/or may a part of a device driver, along with the first IDH component 411b1 and the first ODH component 409b1.

Alternatively or additionally, count information may be received via a higher layer of a network stack. A count component may operate in a network stack. FIG. 4A illustrates the count component 402a operating in the network layer component 403a. In an aspect, part or all of a count component may receive count information via a link layer component. A link layer data unit may include a link layer protocol address of network interface component. A count component 402 may count distinct link layer protocol addresses in a particular region of a network. The count component may be operatively coupled to the link layer component directly and/or may be operatively coupled to the link layer component indirectly via a network layer component, as illustrated in FIG. 4A in the network layer component 403a, and/or one or more application layer components (not shown). A count component may be included at least partially in one or more layers of a network stack.

Detecting a count or a portion thereof may include detecting a change in a state of an operable coupling including a network interface in a region that includes a portion of a network. In an aspect, a state of the operable coupling may be monitored. A count may be changed in response to detecting a change in the state of the operable coupling. In FIG. 4B, a first count component 402b1 may monitor activity of a network interface including the first line card 417b1 by monitoring one or more components of the first line card 417b1. As described above the first count component 402b1 may monitor whether data is received and/or transmitted via the first line card 417b1. The first count component 402b1 may interoperate with the first IDH component 411b1 and the first ODH component 409b1, in one aspect. FIG. 4B, illustrates the count component 402b1 operatively coupled to the first NIC 405b1. Rather than or in addition to monitoring data sent and/or received via the first NIC 405b1 and/or other components of the first line card, the count component 402b1 may monitor power used by and/or available to the first NIC 405b1 and/or a portion of the first NIC 405b1, such as a transceiver component (not shown).

As described above, detecting a change in a state of an operable coupling may include detecting that the state indicates the coupling is inoperative, and subsequently detecting that the state indicates the coupling is operative. Further, detecting a change in a state of a coupling may include detecting that the state indicates the coupling is operative and subsequently detecting that the state indicates the coupling is inoperative.

A count component may monitor one or more operations included in sending data and/or receiving data via an operable coupling including a network and a network interface. Detecting a change in an operable coupling may include performing an operation to send a data unit and/or to receive a data unit via the coupling, then determining whether the operation was successful. In an aspect, a count component 402 in an execution environment 401 may send and/or receive data to detect a state and/or state changes in a coupling of a network interface to a network.

A network protocol may be specified to exchange data between and/or among nodes that include network interfaces in a region and a node including the count component 402 that counts network interfaces in the region. The protocol may include and/or be an extension of one more existing protocols such as the address resolution protocol (ARP), the dynamic host configuration protocol (DHCP), and/or any of numerous network protocols for announcing and/or detecting the presence of a device and/or service on a network. The protocol may be a yet unspecified protocol for determining a count of network interfaces in a region of a network.

A count may be based on whether a network interface in a region is in a node that is configured to send and/or receive a data unit of a particular network protocol via the network interface. A count of network interfaces may be performed according to the method illustrated in FIG. 2 for the purpose of assigning an identifier to a network interface for a particular network protocol. For example, a count of network interfaces may be performed by and/or on behalf of a network layer component 403a configured according to a network layer protocol, such as the internet protocol. A node in a region may not be configured to send and/or receive a data unit of a particular network protocol via a network interface, in the region and in the node. A count component may not include the network interface in detecting a count of network interfaces in the region.

Returning to FIG. 2, a block 204 illustrates that the method further includes determining, based on the count, a threshold condition. Accordingly, a system for assigning an interface identifier to a network interface includes means for determining, based on the count, a threshold condition. For example, the arrangement illustrated in FIG. 3, includes address space condition component 304 operable for and/or otherwise included in determining, based on the count, a threshold condition.

FIG. 4A and FIG. 4B illustrate address space condition components 404 as adaptations and/or analogs of address space condition component 304 in FIG. 3. One or more address space condition components 404 operate in an execution environment 401. In FIG. 4A, an address space condition component 404a is illustrated as a component of a network layer component 403a. In FIG. 4B, address space condition component 404b is illustrated as component of a line card component 411b.

As described below, interface identifiers may be included in protocol addresses. Sizes and threshold sizes associated with storing, processing, and/or transmitting protocol addresses may be determined in order to improve the performance of a particular node, nodes in a particular region, nodes in a network, and performance between a particular pair or among a particular group of nodes. Performance may be defined and/or measured based on any number of attributes including data unit throughput, byte throughput, power utilization, heat, utilization of a processor and/or other hardware component, and various time based metrics. IPv6 addresses allow media access control (MAC) addresses to be included in an IPv6 address as a local portion of the IPv6 address. MAC addresses are 64-bits long. MAC addresses identify specific network interface components and are link layer protocol addresses for some link layer protocols.

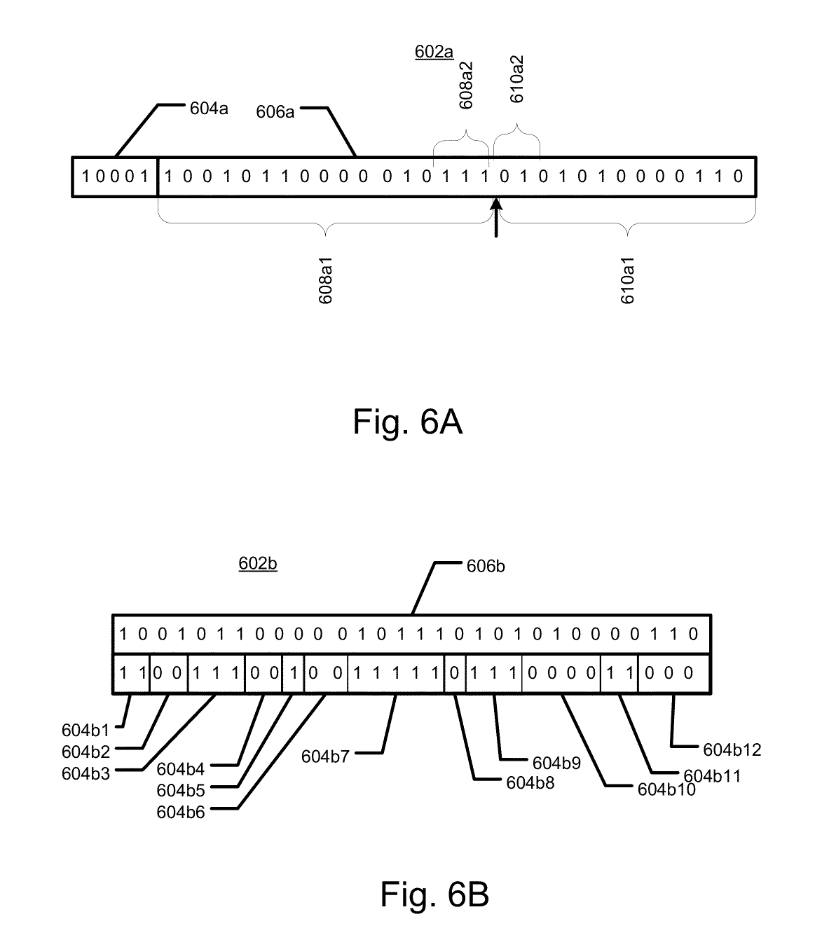

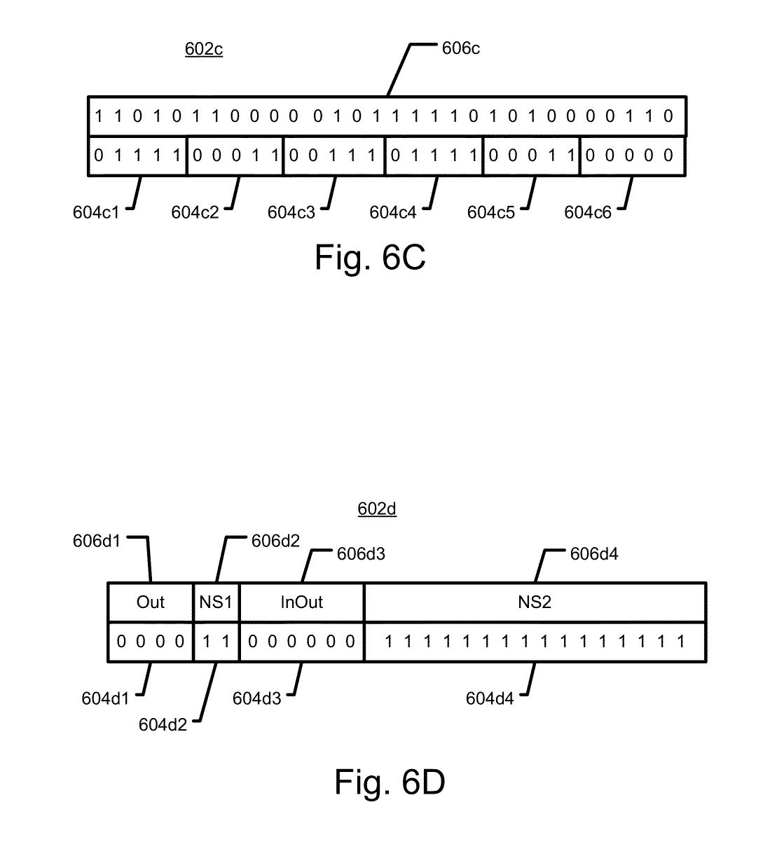

FIGS. 6A-D illustrate a number of new types of address representations 602 illustrating various aspects of address formats and vocabularies for representing protocol addresses for some existing protocols as well as protocols yet to be defined. Protocol addresses that may be identified in address representations 602 may include and/or otherwise may be based on interface identifiers assigned to network interfaces according to the subject matter described herein. Various aspects of the subject matter described herein are described with respect to the address representations 602.

The respective address representations 602 are illustrated including portions that are contiguous, but need not be so in various embodiments. Additionally, the content of any illustrated portion need not be contiguous. The address representations 602 in FIGS. 6A-D may be identified based on a rule for a format of a data unit and/or a rule for a vocabulary of a data unit as defined by a schema for a network protocol. For example, the specification for IPv6 may be extended to include one or more of the address representations 602 and/or their analogs as valid IP addresses. Address representations 602 in FIGS. 6A-D are described with respect to their use in data units of a network protocol. Each of the address types shown in FIGS. 6A-D may be adapted to be included in a destination protocol address portion and/or a source protocol address portion of an IPv4 data unit header and/or of an IPv6 data unit header.

Each address representation 602 may be detected and/or otherwise recognized by one or more components configured according to a network protocol, such as components of a network layer component 403a in FIG. 4A and various components in FIG. 4B. In an aspect, a particular address representation may be detected and/or otherwise identified based on a bit pattern or identifier defined to identify a particular type of address representation. RFC 3513 specifies type bits in an IP data packet header to identify and/or detect a type of address represented in a destination address field and/or in a source address field. A bit pattern or identifier may be located by a component, such as an IDH component 411b in various adaptations of the execution environments 401 in FIG. 4A and in FIG. 4B. Those skilled in the art will realize that neither the schemas described, which define a format rule(s) and/or a vocabulary rule(s) for a protocol address, nor the protocols in which their use is described are exhaustive.

In FIG. 5A, a second path node 504a2 connects nodes in the first region 510a1 and the second region 510a2 with nodes in a number of other regions illustrated in FIG. 5A. The second path node 504a2 may be and/or may include an adaptation, analog, and/or instance of execution environment 401b in FIG. 4B. An address space condition component 404b in the second node 504a2 may determine a condition for minimizing processing time of a first interface identifier assigned to identify for a network protocol a first network interface including a first NIC 405b1 in the second region 510a2 and a second interface identifier assigned to identify a second network interface including a second NIC 405b2 outside of the second region 510a2. In an aspect, an address space condition component 404b may determine a minimum size measured in words as defined by a processor in the second path node 504a2 and/or in measured in bits that will still be large enough to include identifiers for all the counted network interfaces in the second path node 504a2.

A metric for determining a threshold size may be defined to measure a size of a location in a data storage medium for storing an interface identifier. In FIG. 5A, the network topology illustrated indicates that the longest network paths to communicate are a first network path including a third edge node 508a3 and a source node 502a and second network path including the source node 502a and a destination node 506a. An address space condition component 404 in one or more of these nodes or in another node, may determine a threshold condition to minimize the size of interface identifiers that may be stored in a protocol address of a specified network protocol to communicate between the third edge node 508a3 and the source node 502a and/or communicating between the source node 502a and the destination node 506a. In FIG. 5A, the source node 502a is illustrated including single network interface and the first region 510a1 is illustrated as including only one network interface. An address space condition component 404 may determine a threshold condition that defines a size of one bit for storing a representation of an interface identifier of the network interface in the source node 502a in a protocol address. A count of three network interfaces may be detected by a count component 402 in one or more nodes in FIG. 5 for a fourth region 510a4. A threshold condition may be determined that specifies size of 2 bits as a maximum allowable size of an interface identifier for a network interface in the fourth region 510a4, thus minimizing storage requirements for interface identifiers of the network interfaces in the fourth region 510a4.

A metric may be defined to measure a size of a representation of an interface identifier when represented by a specified physical layer protocol carried by a data transmission medium. Alternatively or additionally, a metric may be defined to measure a size of a representation of an interface identifier included in a protocol address in a data unit that is valid according to a specified network protocol. Examples are provided below with respect to FIGS. 6A-D.

In another aspect, a threshold condition may be determined based on a metric defined to measure a size of a time period to process an interface identifier included in a protocol address by a component included in at least one of sending, receiving, and relaying data in a data unit that is valid according to a specified network protocol. The processing may include determining a network interface to forward data, sent from a source node and received in a data unit including a protocol address that identifies a destination node, to a next node in a network path from the source node to the destination node. The processing is based on the interface identifier. In FIG. 4B, address space condition components 404b may determine a threshold condition based on a size of time to process an interface identifier. The determined threshold condition may identify a maximum time period based on one or more of input from a user, an amount of data and/or data unit traffic processed by a node and/or a network interface of the node, an amount and/or cost of energy and/or power utilized in processing an interface identifier.

Returning to FIG. 2, a block 206 illustrates that the method yet further includes identifying a first interface identifier that meets, based on a size attribute of the first interface identifier, the threshold condition. Accordingly, a system for assigning an interface identifier to a network interface includes means for identifying a first interface identifier that meets, based on a size attribute of the first interface identifier, the threshold condition. For example, the arrangement illustrated in FIG. 3, includes address space director component 306 operable for and/or otherwise included in identifying a first interface identifier that meets, based on a size attribute of the first interface identifier, the threshold condition.

FIG. 4A and FIG. 4B illustrate address space director components 406 as adaptations and/or analogs of address space director component 306 in FIG. 3. One or more address space director components 406 operate in an execution environment 401. In FIG. 4A, address space director component 406a is illustrated as a component of a network layer component 403a. In FIG. 4B, address space director component 406b is illustrated as component of execution environment 401b operatively coupled to a SIU component line card component 417b.

Identifying a network interface may include identifying a schema or part of a schema defining a valid format and/or a valid vocabulary for a representation of an interface identifier. Interface identifiers are assigned to network interfaces for a purpose. Interface identifiers may be assigned to network interfaces for routing data, received via a network interface in a node, to another network interface component in the node to relay some or all of data received to another node. Interface identifiers may be included in a protocol address and/or may be included in generating a protocol address for a network protocol as described below. An interface identifier may be included in identifying a network path in a network and/or a hop including a pair of communicatively coupled nodes. As described above interface identifiers may be selected for saving power when processed in performing specific tasks, selected to save storage space, selected to save processing time, and/or selected to save on any number of other costs in performing one or more tasks. A schema may be defined based on one or more tasks and/or purposes associated with processing an interface identifier. FIGS. 6A-D illustrate exemplary aspects of various schemas that may be defined.

Schemas explicitly and/or implicitly define rules for a valid format of an interface identifier and/or rules defining a vocabulary for defining valid content of a representation of an interface identifier. A rule may define a constraint on the format or structure of an interface identifier and/or a constraint on the content of an interface identifier. Such constraints may specify or otherwise identify threshold conditions. A threshold condition may be specified by and/or otherwise based on a schema defining a valid protocol address to identify a protocol endpoint for a particular network protocol. The threshold condition may be determined based on size information defined by the schema for representing the protocol address in the data unit of the network protocol. The size information may identify at least one of a maximum size and a minimum size for a valid representation, according to the schema, of the protocol address in the data unit.

A count of network interfaces may place a constraint on the minimize size of a representation of an interface identifier that is valid according to a specified schema. A schema may define a format rule and/or a vocabulary rule that may identify a maximum count and/or a minimum count. For example, in a schema that defines and/or otherwise allows an interface identifier to be represented by a number, the number of digits or number of identifiers in a suitable address space must be large enough to accommodate the value of the count detected. In binary, a single network interface may be represented by a single digit or bit. A count of seven network interfaces requires an identifier space that includes at least seven identifiers and at least some identifiers in the space require three digits or bits when represented in a binary or base two numeric representation. A schema may define and/or otherwise may be included in determining a constraint on the number of bits that may be used in representing an interface identifier.

In FIG. 5A, the first region 510a1 is illustrated with one network interface. A schema including a rule constraining and/or otherwise allowing identifiers to be represented numerically may be determined by an address space condition component 404a operating in the source node 502a to determine an identifier space that includes at least one identifier. A threshold condition may be determined and/or otherwise identified to minimize the size of a stored representation of an interface identifier when included in a protocol address. The threshold condition may be configured and/or otherwise defined to restrict the identifiers allowed by the schema to the smallest available identifiers. The address space condition component 404a may include the numbers 1 and/or 0 in a determined identifier space, since both numbers each may be represented by a single storage bit. A threshold condition may include a rule that an identifier must have a stored size that is a multiple of the size of a computer word as defined by a processor included in an adaptation of the execution environment 401a. For example, a word for the processor may be defined as 64-bits. The address space condition component 404a may determine the smallest multiple of 64-bits that is greater than or equal to the count detected by a count component 402a interoperating with the address space condition 404a, directly and/or indirectly.

In another aspect, In FIG. 5C, an address space condition component 404b operating in a tenth path node 504c10 may receive, from a count component 402b, count information indicating that a region that includes only the tenth path node 504c10 has a count of network interfaces with a value of two. FIG. 5C, illustrates a network 500c including nodes, such as the tenth path node 504c10 configured to identify network interfaces in the network 500c using identifiers shared by pairs of nodes included in hops. A third hop 512c3 includes the tenth path node 504c10 and an eighth path node 504c8 in a communicative coupling. A count component 402 may detect a count of three network interfaces in the eighth path node 504c8 in one network region and one network interface in the eighth path node 504c8 in another network region. An address space condition component 404 may determine that an identifier space for the three network interfaces must include at least three identifiers and at least two bits of storage are required for storing at least some of the numeric identifiers. An address space condition component 404 in one or both of the tenth path node 504c10 and/or the eight path node 504c8 may determine a threshold condition that meets the same constraints, in an aspect, in order to assign a shared identifier to the third hop 512c3 that also identifies the network interfaces in the hop.

A threshold condition may be based on size information defined by the schema for representing a protocol address in the valid data unit. The size information may identify at least one of a maximum size and minimum size for a valid representation of a protocol address in a data unit. Address representations 602 illustrated in FIGS. 6A-D illustrate a number of rules definable by schemas to define valid protocol addresses for a network protocol, such as versions of the internet protocol. With respect to address representation 602b in FIG. 6B, described below, a representation of an interface identifier of the network interface in the source node 502a in FIG. 5A may be represented by a single bit. A threshold condition may be established and/or otherwise determined to ensure space in an address representation of the interface identifier is minimized.

Determining an interface identifier space may include determining size information identifying at least one of a maximum size for an interface identifier. The maximum size may be based on the count, for an interface identifier; and determining the threshold condition based on the size information. The maximum size may be based on a schema rule.

Returning to FIG. 2, a block 208 illustrates that the method yet further includes providing the first interface identifier as an identifier of the first network interface. Accordingly, a system for assigning an interface identifier to a network interface includes means for providing the first interface identifier as an identifier of the first network interface. For example, the arrangement illustrated in FIG. 3, includes allocate component 308 operable for and/or otherwise included in providing the first interface identifier as an identifier of the first network interface.

FIG. 4A and FIG. 4B illustrate allocate components 408 as adaptations and/or analogs of allocate component 308 in FIG. 3. One or more allocate components 408 operate in an execution environment 401. In FIG. 4A, an allocate component 408a is illustrated as a component of a network layer component 403a. In FIG. 4B, an allocate component 408b is illustrated as a component of a line card component 417b.

Assigning an interface identifier may include determining whether an interface identifier is available. As described, above with respect to FIG. 5C, the tenth path node 504c10 is illustrated with two network interfaces. To minimize a stored size of an interface identifier, an allocate component 408 in the tenth path node 504c10 may attempt to assign and/or suggest an interface identifier of 0 for a network interface in the third hop 512c3 via a communication between the tenth path node 504c10 and the eighth path node 504c8. An address space condition component 404 may determine that the value 0 is unavailable and an address space directory component 406 may determine based on a threshold condition determined and/or otherwise identified by the address space condition component 404 that the smallest interface identifier available is 2. The allocate component 408 may assign 2 to the network interface.

By assigning a smallest available interface identifier, in an identifier space, the length of a network path that can be identified in an address representation 602 may be maximized. In an aspect, a count component 402 may count network interfaces as they are assigned by a corresponding allocate component 408. An address space condition component 404 may adjust and/or redefine a threshold condition in response to the change in the count determined by a count component 402. Assigning an interface identifier may include determining an ordering of interface identifiers in an address space. Further, assigning may include selecting the interface identifier based on the ordering. The interface identifier may be assigned to the network interface, in response to selecting the interface identifier. The description in the previous paragraph illustrates an allocate component selecting an interface identifier based on an ordering of identifiers according to a storage representation size.

An ordering of interface identifiers in an identifier space may be determined based on a metric. The metric may be for measuring of any of various attributes accessible within an execution environment. Examples of metrics for interface identifiers are provided above in describing threshold conditions.

Further, an ordering of interface identifiers may correspond to an ordering of network interfaces. Interface identifiers may be assigned based on the correspondence. In an aspect, interface identifiers may be order based on a size of their respective representations in data units of a network protocol. For example, an interface identifier with the value 1 may be represented by a single bit in a data unit. An identifier with a value of ‘255’ may require 4 bits according to a particular type of representation. Network interfaces in a node may be ordered based on one or more of data units sent and/or received; bytes sent and/or received; types of data transmission media coupled to respective network interface; a measure of congestion; a measure of energy or power utilization; measure of heat; an attribute of specified protocol configured to communicate via the network interfaces; and a role of a next node included in a hop that includes a network interface.

For example, in FIG. 5A, a fourth path node 504a4 may be and/or may include an adaptation of the execution environment 401b. A network interface included in communicatively coupling the fourth path node 504a4 to a third path node 504a3 may transmit and receive more data in terms of bits, bytes, and/or data units of a particular protocol than two other network interfaces in the fourth path node 504a4. An allocate component 408a and/or other suitably configured component may receive and/or determine an ordering of network interfaces based on a measure of data transmitted and/or received over a period of time. The allocate component 408b may also order interface identifiers by a numeric size. The allocate component 408a, in an aspect, may assign the network interface with the highest measure of data throughput the smallest numeric identifier. Network interfaces with higher throughput may be assigned smaller numeric identifiers than network interfaces with lower throughput.

Assigning an interface identifier to a first network interface in a first node may include receiving, via the first network interface, a message, sent via a second network interface in a second node, that includes criterion information to identify and/or assign an interface identifier. A criterion may be based on and/or may identify any of the measures described above. Assigning the interface identifier may further include determining that the first interface identifier meets the criterion. A threshold condition determined by an address space component may be determined based on such a criterion. The first interface identifier may be assigned to the first network interface in response to determining that the criterion is met by the first interface identifier. See the description above with respect assigning an identifier to the third hop 512c3 in FIG. 5C. In another aspect, a node, such as the first edge node 508a1 may include an allocate component 408 or a portion of a distributed allocate component in a system configured to assign network identifiers to network interfaces in the second region 510a2. The allocate component 408a in the first edge node 508a1 may receive a message from the second edge node 508a2 requesting an interface identifier to identify a network interface included in the second edge node 508a2.

In another aspect, the first edge node 508a1 may receive a message from one or more other nodes in the second region 510a2 that identifies interface identifiers already assigned to one or more network interfaces in the second region 510a2. An allocate component 408a in the first edge node 508a1 may select an available identifier based on the criterion received in the information from the one or more other nodes in the second region 510a2. As described, a criterion may be received by a first network interface in a first node from a second node via a second network interface, where both the first network interface and the second network interface are in the same region. The example described above with respect to the third hop identifier 512c3 in FIG. 5C illustrates that a criterion may be communicated between nodes in different regions.

In transmitting data from a source protocol endpoint in a source node 502 to a destination protocol interface in a destination node 506, the data is processed by a sequence of nodes in a network path that communicatively couples the source node 502 and the destination node 506. A node in the network path that is currently processing the data to send it to the destination 506, is referred to herein as a “current node” with respect to the data or more precisely referred to as a “current path node” when the current node is a path node. A node in the network path that has previously transmitted the data being processed by the current node is referred to herein as a “previous node”. A node in the network path that has not received the data being processed by the current node is referred to herein as a “next node”. For ease of description, “data” with respect to a data unit refers to data sent in the data unit via a protocol endpoint of a network protocol in the source node being processed by a path node, current to the data, to transmit to a next node in a network path to an identified destination node. As such, a source node 502 may be a one of a current node and a previous node with respect to particular data. A path node 504 may be one of a current node, a previous node, and a next node with respect to particular data. A destination node 506 may be one of a next node and a current node with respect to particular data.

FIG. 6A illustrates address representation 602a that may be detected in a data unit or packet of an Internet Protocol or other network protocol. An address representation 602a may identify one or both of a source address and a destination address respectively identifying a source node 502 and a destination node 506. In an aspect, an address representation 602a may be processed as including at least three portions. An address separator field 604a is illustrated including a binary number. In FIG. 6A, the binary number illustrated equals seventeen in base ten. The number in the address separator field 604a identifies the size in an address information field 606a of a previous address field 608a to identify the previous address field 608a and a next address field 610a.

A routing component 413, in a current node, may process information in a previous address field 608a to identify a previous address that identifies the current node to a previous node. A routing component 413 may identify, based on information in a next address field 610a, a next protocol address that identifies a next node in the network path to the current node. Alternatively or additionally, a routing component 413 may identify, based on information in a next address field 610a, a current protocol address that identifies the current node to a next node. A routing component 413 interoperating with an in-data handler component 411 may determine a next protocol address that identifies the next node to the current node. In another aspect, a routing component 413 may determine the current address based on the next protocol address.

With respect to FIG. 5A, an address representation 602a may be included in a data unit including data from a source node 502a, in a first region 510a1, to transmit to a destination node 506a. FIG. 5A illustrates, the sequence, 1.2.2.0.2, may be represented in an address information field 606a to identify a protocol address that identifies the destination node 506a with respect to the source node 502a.

At the source node 502a, the address separator field 604a may be set to include a size of zero for a previous address field 608a. The address information field 606a, thus includes a next address field 610a at the source node 502a and identifies the destination node 506a with respect to nodes in the first region 510a1.

In an aspect, a first node may receive data from a second node in a data unit of a network protocol via a first network interface. The first network interface may have an assigned first interface identifier. The data may be received based on a protocol address of the network protocol that includes the first interface identifier. The protocol address may identify a third node. In an aspect, the protocol address may include a second interface identifier. The second interface identifier may be assigned to identify a second network interface in the first node. The first node may transmit the data to the third node via the second network interface identified by the second interface identifier in the protocol address. In another aspect, the protocol address may include a third interface identifier assigned to a third network interface in the third node. The third network interface may be included in communicatively coupling the first node and the third node via the second network interface in the first node. In an aspect, the first node may transmit the data to the third node via the second network interface based on an association between the third interface identifier and the second network interface.

At a first path node 504a1, outside the first region 510a1, an address separator field 604a in a data unit including the data from the source node 502a, may include a value of 1 that identifies, in a previous address field 608a, a network interface in the first path node 504a1 by which data from the source node 502a was received. A routing component 413 in a first path node 504a1 may detect the value. The routing component 413 may also identify, based on the value in the address separator field 604a, a next address field 610a that identifies 2.2.0.2 as a next protocol address that identifies the destination node 506a. The routing component 413 may detect the next protocol address. Note that 2.2.0.2 identifies the destination node 506a with respect to all the network interfaces in second region 510a2 to transmit data from a node in the second region 510a2 to the destination interface.

With respect to the destination node 506a, the second path node 504a2 is not considered to be in the second region 510a2 since the network interface in the second path node 504a2 that is included in communicatively coupling the second path node 504a2 to the destination node 506a is not included in the second region 510a2. The first path node 504a1, with respect to the destination node 506a, is included in the second region 510a2 since it has a network interface, in the second region 510a2, that is included in communicatively coupling the first path node 504a1 with the destination node 506a. Similarly, the second path node 504a2 is included in the second region 510a2 with respect to the source node 502a and the first path node 504a1 is not included in the second region 510a2 with respect to the source node 502a.

At the destination node 506a a data unit including the data from the source node 502a may include a value in an address separator field 604a that indicates that the address information field includes only a previous address field 608a identifying 1.2.2.0.2, which is the destination protocol address when interpreted in the context of the first region 510a1.

As the data from the source node 502a is transmitted from node to node in the network path the value represented in an address separator field 604a in an address representation 602a in a data unit including the data or a portion thereof may be adjusted to identify a protocol address in a suitable address space for the respective nodes in the network path.

The above description describes an address representation 602a processed in the role of a destination protocol address in a data unit of a network protocol, such as an IP protocol. As a source protocol address with respect to a data unit, described in the previous paragraph, sent from the source node 502a to the destination node 506a, an address information field 606a, at the second path node 504a2, may include a previous address field 608a identifying the sequence 0.0 that identifies a protocol address that identifies the source node 502a as a sender of the data in the data unit.

Note that the address 0.0 identifies the source node 502a node to all nodes communicating with the source node 502a via network interfaces in the second region 510a2. The address information field 606a including the source address information at the second path node 504a2 may include a next address field 610a, identified by an address separator field 604a, identifying the sequence 3.1.0 that identifies a protocol address that identifies the second path node 504a2 to the destination node 506a as a path node 504a in a network path traversed by the data sent from the source node 502a.

Address information may be based on path information for a network path included in communicatively coupling a pair of network interfaces in a pair of nodes in a network. Detecting address information may include determining path information identifying a network path included in communicatively coupling a source node and a destination node. Address information may include and/or otherwise identify the path information.

FIG. 6B illustrates an address representation 602b identifying path information that may be detected by a routing component 413. An address information field 606b may be interpreted as a network path identifier based on address separator field(s) 604b in a data unit. Address separator fields are specified according to a network protocol to distinguish one path identifier from another path identifier in an address information field 606b.

In one aspect, illustrated in FIG. 6B, a routing component 413 and/or an in-data handler component 411 may distinguish hop identifiers, since a single hop is a network path. A routing component 413 may distinguish separate hop identifiers based on changes in values in bits of consecutive address separator fields 604b. In FIG. 6B, a first address separator field 604b1 includes one or more 1-valued bits that correspond to bit positions in the address information field 606b to identify a previous address field referred to in FIG. 6B as a first hop information field. Network paths that include more than one hop may be distinguished similarly as shown in FIG. 6B. Combinations of hop identifiers and path identifiers may be distinguished by a routing component 413 and/or an in-data handler component 411 based on information in address separator fields 604 A second hop information field 604b2, in FIG. 6B, includes two ‘0’ valued bits to identify a second hop information field in address information field 606b. Additional alternating sequences of 1′ valued bits and 0-valued bits illustrated by address separator fields 604b3-12c correspond to and identify other hop information fields identifying hops in a network path communicatively coupling a source node 502 and a destination node 506.

In an aspect, the method in FIG. 2 may further include determining a first hop identifier, based on the first interface identifier. The first hop identifier identifies a communicative coupling between the first node and a second node via the first network interface and via a second network interface in the second node. Still further, the method may include associating the first hop identifier with the first network interface. Data may be received in a data unit that includes a protocol address that includes the first hop identifier. The data may be relayed to a next node via the first network interface based on the association.

In FIG. 5C, a hop may be identified by an interface identifier that may identify directly and/or may identify indirectly one or more network interfaces in a pair of communicatively coupled nodes included in the hop. For example, the number 2 may serve as a hop identifier to the tenth path node 504c10 to identify a third hop 512c3 that includes the tenth path node 504c10 and the eighth path node 504c8. The number 2 may also identify a network path for exchanging data between the two nodes. The number 2 may also be a protocol address that identifies the tenth path node 504c10. The number 2 may also identify a hop for the tenth path node 504c10 to exchange data with the eighth path node 504c8 and may also be a protocol address identifies the eighth path node 504c8 to the tenth path node 504c10 and may identify a particular network interface component of the eighth path node 504c8.

A source node 502c may identify a destination node 506c by a destination protocol address that identifies a network interface of the destination node 506c. The protocol address may be based on a sequence of hop identifiers 0.1.3.2.3.0.51. Note that other network paths are illustrated to transmit data from the source node 502c to the destination node 506c and may also identify protocol addresses that identify the destination node 506c to nodes in the first region 510c1.

A seventh path node 504c7 in the identified network path may identify the destination node 506c based on another sequence of hop identifiers 3.0.51. The sequence of hop identifiers may identify a protocol address that identifies the destination node 506c. Note that a routing component 413 operating in the seventh path node 504c7 may detect the sequence, 3.0.51 in and/or otherwise based on the protocol address of the destination node 506c. Further, the routing component 413 may detect a protocol address for the eighth path node 504c8 as well as a protocol address for the ninth path node 504c9, in and/or otherwise based on the sequence, 3.0.51. The destination node 506c is in a third region 510c3. Within the third region 510c3, the destination node 506c may be identified by a local-scoped address, ‘51’.

The hop identifiers 0.1.3.2.3.0.51 may be represented in an address representation 602b in a data unit for sending data from the source node 502c to the destination node 506c. At the seventh path node 504c7, a routing component 413 may determine and/or otherwise detect a protocol address of a next node based on a next address field identifying the sequence 3.0.51. The identifiers may be given a bit or binary representation and the hop identifiers may be distinguished or separated via address separator fields 604b as described above with respect to FIG. 6B. An address separator field analogous to that shown in FIG. 6A may also be included and processed as described above.

In another aspect, a first node may receive a message via a second network interface in the first node. The message may be from a second node in a network path that includes the second network interface. The message may include and/or may be received in one or more data units that include and/or identify a protocol address of a network protocol of the message or of the data units that include the message. The network protocol includes a first interface identifier assigned to a first network interface in the first node. The first node identifies the first network interface based on the first interface identifier in the protocol address. In response, the first node may send the message to a third node in a network path from the first node, where the network path includes the first network interface. The protocol address may be a valid address according to the network protocol of the third node. Alternatively, the third node may be a node in a network path to a destination node identified by the protocol address.

Note that the address information, that identifies one or more protocol addresses for the seventh path node 504c7 and for the destination node 506c in the preceding description, may include information to identify a return path or a portion thereof. For example, the sequence address 3.0.51 identifies 0.3, which may be a protocol address that identifies the seventh path node 504c7 for the ninth path node 504c9 operating as a gateway for nodes in the third region 510c3. The sequence 0.1.3.2 identifies 2.3.1, that identifies a network path from the seventh path node 504c7 to a node having a network interface in first region 510c1, illustrated by a second path node 504c2.

Separate source address information may be included in a data unit received by the seventh path node 504c7 that includes data sent from the source node 502c. Address information in the data unit may include a source protocol address representation 602b that may identify 2.3.1.101 as a protocol address that identifies the source node 502c. Note that ‘101’ may identify a hop in the first region 510c1 from the second path node 504c2 to the source node 502c, in some aspects. For example, subnet 510c1 may be a LAN. In other aspect, ‘101’ may be a scoped address that identifies the source node 502c in the scope of the first region 510c2.

As described in the previous paragraph, a hop may be assigned an identifier that is shared by the pair of nodes in the hop. In still another aspect, a first-second protocol address may indicate a first ordering of the first interface identifier and the second interface identifier. The first-second protocol address may identify the second node to the first node based on the first ordering. A second-first protocol address may include and/or otherwise indicate a second ordering of the first interface identifier. The second-first protocol address may identify the first node to the second node based on the second ordering.

FIG. 6C includes an address representation 602c illustrating a schema for representing path information based on identifiers of network interfaces included in a hop and/or path end nodes in a network path. A routing component 413 and/or an in-data handler component 411 may operate based on the schema or a portion of the schema. An address information field 606c includes path information to identify a network communicatively coupling a pair of path end nodes in a network path. FIG. 6C illustrates that an address representation 602c may include one or more address separator fields 604c that correspond to and/or otherwise identify respective one or more portions of the address information field 606c that are based on one or more pairs of identifiers of network interfaces of path end nodes. An address separator field 604c includes series of 1-valued bits and/or 0-valued bits. A change from a 1 value to a 0 value and/or vice versa may indicate, to a routing component 413 and/or an in-data handler component 411, a boundary separating interface identifiers. Since a network path may consist of a single hop, a pair of interface identifiers corresponding to an address separator portion 604c may identify network interfaces in a hop in a network path. An address separator field 604c1 includes one 0-valued bit followed by four 1′ bits. The 0-valued bit may be defined to indicate that a first network interface in a first hop identifier is one bit long with a corresponding position in the address information field 606c. FIG. 6C identifies the first interface identifier as the number 1 in base ten. The four 1-valued bits in the first address separator field 604c1 may be similarly defined to identify the location of a second interface identifier in the first hop identifier.

The second interface identifier, as illustrated in FIG. 6C, has the value 10 in base ten. The first hop identifier includes the numbers 1 and 10. A second hop identifier is located by the end of the series of four 1 bits in the first address separator field 604c1 identified by a series of three 0-valued bits that identify a boundary of a second address separator field 604c2 for second hop information identifying a second hop identifier. The three' 0-valued bits also identify the location of a first interface identifier in second hop information in the address information field 606c. Two subsequent 1-valued bits identify the location in the address field 606c of a second interface identifier in the second hop information. The second hop identifier includes the numbers 6 and 0 in base ten. The remaining address separator fields 604c may be processed similarly.

With respect to FIG. 5A and FIG. 6C, a protocol address for sending data from the source node 502a to the destination node 506a may be represented textually as 0-1.0-2.0-2.1-0.3-2. With respect to the source node 502a, the address includes an interface identifier 0 assigned to the network interface in the source node 502a. The protocol address includes identifiers for all of the nodes in a network path from the source node 502a to the destination node 506a. The first hop identifier 0-1 is a protocol address that may be represented according to the address representation 602c in FIG. 6C that identifies the first path node 504a1. Similarly, with respect to the source node 502a, the protocol address 0-1.0-2 identifies the second path node 504c2, the protocol address 0-1.0-2.0-2 identifies the third path node 504c3, the protocol address 0-1.0-2.0-2.1-0 identifies the fourth path node 504a4, and as indicated above the protocol address 0-1.0-2.0-2.1-0.3-2 identifies the destination node 506a.

As illustrated in the previous paragraph, in an aspect of the method illustrated in FIG. 2, a hop identifier may be determined based on both a first interface identifier and a second interface identifier that respectively identify a first network interface and a second network interface included in a pair of nodes included in a hop identified by the hop identifier. A hop identifier may include the first interface identifier and the second interface identifier.

FIG. 6D illustrates an address representation 602d that may include portions that include path information and/or portions that include scoped protocol addresses. A routing component 413 may distinguish protocol address portions based on address separator fields 604d. Address separator fields 604d may be defined to identify protocol address portions in a manner similar to the method described for distinguishing hop identifiers in FIG. 6B. A previous address information field 606d1, in FIG. 6D, corresponding to a first address separator field 604d1 includes a single interface identifier for an outbound network interface for a source node 502 as described above with respect to FIG. 6A and FIG. 5C. A next address information field 606d2 corresponding to a second address separator field 604d2 may include a scoped protocol address having an inside scope, an outside scope, or both. A node processing the second address information field 606d2 may be included in a portion of a network spanned by the scope of the scoped protocol address. The node may process the scoped protocol address accordingly. See application Ser. No. 11/962,285, by the present inventor, filed on 2007 Dec. 21, entitled “Methods and Systems for Sending Information to a Zone Included in an Internet Network”, for a description of addresses having outside scope and/or inside scope and processing of such addresses. A third address information field 606d3 corresponding to a third address separator field 604d3 may include a pair of identifiers as described with respect to FIG. 6C. A fourth address information field 606d4 corresponding to a fourth address separator field 604c4 may include a protocol address analogous to one of the types of addresses described with respect to the next address information field 606d2 such as an local-scoped address.

In an additional aspect, the method illustrated in FIG. 2 may include detecting a portion of a data unit, that is valid according to a network layer protocol, for representing a protocol address. The protocol address may identify a sender and/or a receiver of data included in the data unit. A hop threshold size may be determined for including a representation of a hop identifier in the detected portion. The hop threshold size may be determined based on a size of the hop identifier. A representation of the hop identifier may be stored in a hop location where the hop location has a size that meets a threshold condition based on the hop size.

With respect to FIG. 5C and FIG. 6D, an out-data handler component 409a operating in the source node 502c may detect a portion of a data unit for storing a valid protocol address according to the address representation 602d in FIG. 6D and described above. The protocol address represented according to a schema consistent with address representation 602d may identify the source node and/or may identify the destination node 506c according to a schema for the data unit. The sequence of hop identifiers, which also identify network interfaces 101-0.1.3.2.3.0.2-51 may be represented in an address representation 602d as it includes different types of hop identifiers. The sequence, as ordered, identifies the destination node 506a with respect to the source node 502c. Ordered as 51-2.0.3.2.3.1.0-101 the sequence identifies the source node 502c with respect to the destination node 506c.

Note that the various nodes in the network path including and between the source node 502c and the destination node 506c are included in regions 510c that have different network interface counts. As such, interface identifier spaces for the respective regions 510c may have a different size or number of identifiers in the respective spaces, different maximum sizes of numeric interface identifiers, different minimum sizes of storage space required to store a representation of an interface identifier, and/or other attributes that vary according to a measure of size. Threshold conditions may be determined and/or otherwise identified for one or more interface identifier related entities with attributes having a size. For example, a threshold size for storing a representation of an identifier of the second hop 512c2 in the protocol address may be determined to be one bit for a data storage medium and/or an analog of one bit as represented in a data transmission medium. The hop storage size threshold is based on the value 0 of the second hop identifier 512c2. A representation of the 0 valued bit may be stored in a hop location that corresponds to the location of the second hop 512c2 in the protocol address 51-2.0.1.3.2.3.1.0-101.

A hop size threshold condition may specify a maximum size required by a maximum size hop identifier in a hop identifier address space. In another aspect, a hop location size threshold condition may specify a maximum hop location size required by a particular hop identifier. The one-bit threshold size determined for a stored representation of the hop identifier of the second hop 512c2 is a minimum size of the storage location and may specify, in an aspect a maximum size for the particular interface identifier of the second hop 512c2.

The method illustrated in FIG. 2 may include additional aspects supported by various adaptations and/or analogs of the arrangement of components in FIG. 3. In an aspect, the method may include determining that a protocol address, that is specified according to a network protocol, includes a first interface identifier assigned to a first network interface. Further, the method may include determining that the protocol address includes an identifier of a second node in a network path that includes the first network interface. Determining that the second node is included in the network path that includes the first network interface may be based on the first interface identifier. The first interface identifier may identify the first network interface to transmit a data unit, of the network protocol, that includes and/or otherwise identifies the protocol address.

In another aspect a count may be detected by a count component based on whether a network interface in the region is in a node configured to at least one of send and receive a data unit specified according to a network protocol.

An address space condition component may determine a threshold condition based on an interface identifier space to identify a protocol endpoint of a network protocol. Determining the threshold condition may include determining, based on the count, a maximum count of interface identifiers in the interface identifier space

Further, a threshold condition may be based on a metric to measure an address portion of a data unit, of a network protocol, in a data transmission when transmitted via a data transmission medium. The threshold condition may be based on a metric to measure a size of an interface identifier in a protocol address when stored in the address portion.

In a further aspect identifying an interface identifier may include identifying an interface identifier space based on a threshold condition. The interface identifier interface identifier may be selected from the interface identifier space for assigning to a network interface.

In another aspect a first node may receive data, from a second node via a first network interface, in a data unit including a protocol address, of a protocol endpoint of a network protocol, that includes a first interface identifier of the first network interface. The protocol address may be a valid identifier of a third node that is included in a network path that includes a second network interface in the first node. The first node may send the data to the third node via the second network interface. The protocol address includes a second interface identifier assigned to identify the second network interface.

An interface identifier may be assigned to a first network interface in a first region in a node including a second network interface in a second region of a network. Assigning the first network interface may include determining that the first interface identifier is the smallest available interface identifier.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that operate to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a non-transitory computer readable medium for use by or in connection with an instruction execution machine, system, apparatus, or device, such as a computer-based or processor-containing machine, system, apparatus, or device. As used here, a “non-transitory computer readable medium” may include one or more of any suitable media for storing the executable instructions of a computer program in one or more of an electronic, magnetic, optical, and electromagnetic form, such that the instruction execution machine, system, apparatus, or device may read (or fetch) the instructions from the non-transitory computer readable medium and execute the instructions for carrying out the described methods. A non-exhaustive list of conventional exemplary non-transitory computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for assigning an interface identifier to a network interface, the method comprising:
detecting a count of network interfaces in a first region, of a network, that includes a first network interface operatively coupling a first node to the first region;
determining, based on the count, a threshold condition;
identifying a first interface identifier that meets, based on a size attribute of the first interface identifier, the threshold condition; and
providing the first interface identifier as an identifier of the first network interface,
wherein performing at least one element identified as comprising the method includes execution of an instruction by a processor.

2. The method of claim 1 wherein detecting the count includes determining that a plurality of network interface components in the first region are included in a same node.

3. The method of claim 2 wherein detecting the count includes determining that the network interface components in the plurality are included in single network interface.

4. The method of claim 2 wherein detecting the count includes:
determining that a network interface component in the plurality is included in a network interface; and
determining that another network interface component in the plurality is included in another network interface.

5. The method of claim 1 wherein the count is based on whether a particular network interface in the region is in a node that is capable of at least one of sending and receiving a data unit of a specified network protocol via the particular network interface.

6. The method of claim 1 includes determining the threshold condition based on a schema defining a type of protocol address of a specified network protocol.

7. The method of claim 6 wherein the threshold condition is determined based on size information, identified based on the schema, for representing the protocol address of defined type in the data unit of the network protocol, wherein the size information identifies at least one of a maximum size and a minimum size for a representation in the data unit of a portion of the protocol address that is based on the first interface identifier.

8. The method of claim 1 wherein the threshold condition is based on at least one of a metric to measure a size of a location in a data storage medium for storing a representation of a protocol address, based on the first interface identifier, and a metric to measure a size of a representation of the protocol address in a data unit, of a network protocol, in a data transmission medium.

9. The method of claim 1 wherein the threshold condition is based on a metric to measure a time period to process a protocol address, based on the first interface identifier, in at least one of sending, receiving, and relaying data according to a network protocol.

10. The method of claim 1 wherein providing the first interface identifier includes:
determining an order of a plurality of interface identifiers in an interface identifier space;
selecting, based on the order, the first network interface from the interface identifier space; and
assigning the selected first interface identifier to the first network interface.

11. The method of claim 1 wherein providing the first interface identifier includes:
receiving a message, sent via a network by a second node, that includes criterion information identifying a criterion for assigning an interface identifier to the first network interface;
determining the first interface identifier meets the criterion; and
assigning the first interface identifier to the first network interface, in response to determining the criterion is met by the first interface identifier.

12. The method of claim 1 further includes sending data, to a second node via the first network interface, in a data unit identifying a protocol address, of a network protocol, that includes another protocol address that includes the first interface identifier and that identifies a third node that is included in a network path that includes the first network interface and the second node.

13. The method of claim 1 includes:
receiving data, from a second node via the first network interface, in a data unit including a protocol address, of a network protocol that includes the first interface identifier and that identifies of a third node that is included in a network path that includes a second network interface in the first node; and
sending the data to the third node via the second network interface, wherein the protocol address includes a second interface identifier that identifies the second network interface.

14. The method of claim 1 includes:
receiving data, sent from a source node, in a data unit of a network protocol, wherein the data unit includes a protocol address that identifies a destination node;
detecting the first interface identifier in the protocol address;
sending the data, via the first network interface in response to detecting the first interface identifier, to a next node in a network path to the destination node.

15. The method of claim 1 wherein providing the first interface identifier includes:
determining a first hop identifier, based on the first interface identifier that identifies a first hop including the first node and a second node communicatively coupled via the first network interface and via a second network interface in the second node; and
associating the first hop identifier with the first network interface.

16. The method of claim 15 further includes relaying data, to the second next node via the first network interface, received in a data unit that includes a protocol address, of a network protocol, that includes the first hop identifier.

17. The method of claim 15 wherein the first hop identifier is determined based on both the first interface identifier and a second interface identifier that identifies the second network interface.

18. The method of claim 1 further includes:
identifying a portion of a data unit, that is valid according to a network protocol, for representing a protocol address of the network protocol;
identifying that the threshold condition is met by determining a size of a representation of the first interface identifier when included in the detected portion; and
providing the first interface identifier as an identifier of the first network interface by storing the representation of the first interface identifier in the detected portion, in response to identifying that the first interface identifier meets the threshold condition.

19. A system for assigning an interface identifier to a network interface, the system comprising:
a count component that during operation of the system is included in detecting a count of network interfaces in a first region, of a network, that includes a first network interface operatively coupling a first node to the first region;
an address space condition component that during operation of the system is included in determining, based on the count, a threshold condition;
an address space director component that during operation of the system is included in identifying a first interface identifier that meets, based on a size attribute of the first interface identifier, the threshold condition;
an allocate component that during operation of the system is included in providing the first interface identifier as an identifier of the first network interface; and
a processor, wherein at least one of the count component, the address space condition component, the address space director component, and the allocate component includes an instruction that is executed by the processor during operation of the system.

20. A non-transitory computer-readable data medium embodying a computer program, executable by a machine, for assigning an interface identifier to a network interface, the computer program comprising executable instructions for:
detecting a count of network interfaces in a first region, of a network, that includes a first network interface operatively coupling a first node to the first region;
determining, based on the count, a threshold condition;
identifying a first interface identifier that meets, based on a size attribute of the first interface identifier, the threshold condition; and
providing the first interface identifier as an identifier of the first network interface.
